(19) United States
(12) Patent Application Publication
(10) Pub. No.: US 2021/0163117 A1
(43) Pub. Date: Jun. 3, 2021

(54) AIRCRAFT FOR TRANSPORTING CARGO AND PASSENGERS, CARGO CONTAINER, METHOD FOR LOADING AN AIRCRAFT AND METHOD FOR RECONFIGURING AN AIRCRAFT

(71) Applicant: TELAIR INTERNATIONAL GMBH, Miesbach (DE)

(72) Inventor: Thomas HUBER, Schliersee (DE)

(21) Appl. No.: 17/103,326

(22) Filed: Nov. 24, 2020

(30) Foreign Application Priority Data
Nov. 28, 2019 (DE) 102019132396.7
Dec. 3, 2019 (DE) 102019132823.3

(51) Int. Cl. B64C 1/20; B64C 1/14

(52) U.S. Cl. CPC B64C 1/20; B64C 2025/125; B64C 1/1415

(57) ABSTRACT

An aircraft for the transport of cargo and/or passengers, comprising a fuselage extending in longitudinal direction and having an upper deck, in particular main deck, and a lower deck separated from each other by a floor, wherein the fuselage comprises a barrel section with a cross-sectional profile for accommodating cargo and/or passengers, wherein the cross-sectional profile is essentially formed by several, in particular four, circular arc sections, which have radii (R1, R2, R3) with centers (M1, M2, M3′, M3″) differing from one another, so that the cross-sectional profile is designed in such a way that cargo items with different size dimensions, in particular cargo containers with different height and width dimensions, can be accommodated in the upper deck and the lower deck.

### CROSS REFERENCE TO RELATED APPLICATIONS

This application claims priority to German Patent Application No. 102019132396.7, filed Nov. 28, 2019, and German Patent Application No. 102019132823.3, filed Dec. 3, 2019. The disclosures set forth in the referenced applications are incorporated herein by reference in their entirety.

### BACKGROUND

The invention relates to an aircraft transporting cargo and/or passengers, a cargo container, a method for loading and unloading an aircraft and a method for reconfiguring an aircraft. An aircraft is known from U.S. Pat. No. 6,834,833 B2, for example.

Aircraft are used for different purposes during their lifetime. Aircraft for passenger transport are mainly used for the transport of cargo or cargo items after an appropriate period of operation. In general, the aircraft may have a main deck and a lower deck, which is used to transport cargo while the aircraft is used for passenger transport.

When transporting cargo in aircraft, cargo items, e.g. containers or pallets (“Unit Load Devices—ULDs”), are often used which are cuboid or trapezoidal or have a shape with a special outer contour. Such containers or pallets can be loaded lengthwise or crosswise, depending on the cargo space of the aircraft. Thus, the following standard sizes relevant in connection with this application exist for containers and pallets, for example for civil aviation. The following standardized dimensions of containers and pallets are each specified in length×width×height.

As is generally known, containers and pallets (“ULDs”) are classified by three letters according to a regulation of the “International Air Transport Association” (IATA). In the following, only the most important ones are explained:
The first letter defines the type of cargo item. The letter A indicates a certified container or the letter P indicates a certified pallet with net combination;
The second letter gives information about the floor size, i.e. the base area of the package, and
The third letter describes the outline or design of the package.

Containers and pallets for transport in the main deck of an aircraft essentially have the following standardized dimensions:
223.5×317.5×243.8 cm (88×125×96 in). These dimensions apply to AAJ containers and PAG pallets;
223.5×317.5×208.2 cm (88×125×82 in). Such dimensions include AAA, AAC, AAY and AAZ containers and PAG pallets;
243.8×317.5×243.8 cm (96×125×96 in). Such cargo items are known as AMA and AMJ containers and PMC pallets;
243.8×497.8 cm (96×196 in) or 243.8×605.7 cm (96×238.5 in). These dimensions correspond to the base area of pallets with a specific contour, such as the contour of an engine or vehicle or special cargo. Such pallets are commonly referred to as PRA or PGA pallets;
223.5×274.3 cm (88×108 in) and 137.1×223.5 cm (54×88 in). These dimensions correspond to the base area of pallets with a specific contour determined by military goods, such as cargo or ISU containers. Such pallets are called HCU-6E, PBN or HCU-12E pallets.

Containers and pallets for transport on the lower deck of an aircraft have the following standardized dimensions:
The following dimensions correspond to the base area of containers or pallets with a specific contour. The contour is determined by a contour of the lower deck or the cargo space contour of the aircraft and/or by a required loading height for specific cargo and/or by an already existing standardized cargo item contour. 223.5×317.5 cm (88×125 in) or 243.8×317.5 cm (96×125 in). Pallets with such base areas are referred to as PAG pallets or PMC pallets;
153.4×156.2 cm (60.4×61.5 in). This base area applies to AKE, AKH and AKG containers and PKC pallets;
156.2×243.8 cm (61.5×96 in). This is the base area of PNA pallets;
153.4×243.8 cm (60.4×96 in). This is the base area of PQA pallets; and
153.4×119.4 cm (60.4×47 in). This corresponds to the base area of PPA pallets or APE/DPE containers.

From the initially mentioned U.S. Pat. No. 6,834,833 B2, an aircraft is known which has seven rows of seating with two longitudinal aisles on the main deck for passenger transport and a cargo space for cargo items on the lower deck. The aircraft also has an oval fuselage with a width of 201 inches and a height of 187 inches. The aircraft is designed in a high-deck configuration, with the cargo space bounded on the sides by side walls and on the top by a floor. In addition, the cargo space is designed to accommodate trapezoidal containers with a base area of 153.4 cm×156.2 cm (60.4 inches×61.5 inches) and a height of 114.3 cm (45 inches). The cargo space is designed continuously on the lower deck, i.e. without interruption by the wing box or landing gear. This is made possible by the high wing configuration of the aircraft, since the wing box is located above the fuselage in the z-direction. The cargo space described in U.S. Pat. No. 6,834,833 B2 has the disadvantage that it cannot accommodate a container with the basic dimensions of 153.4 cm×243.8 cm (60.4 inches×96 inches) or pallets (88×125 inches) or (96×125 inches) or (88×108 inches). The cargo space has too little clearance in the transverse direction of the aircraft for this purpose.

In particular, aircraft designed for the application segment between narrow-body aircraft and wide-body aircraft often have a reduced load volume in the main and cargo decks.

In addition, aircraft are known from the prior art in which the main deck is designed to accommodate containers or pallets with basic dimensions of 223.5 cm×317.5 cm (88 inches×125 inches) and 243.8 cm×317.5 cm (96 inches×125 inches) as well as engines of the own aircraft type and military pallets with basic dimensions of 274.3 cm×223.5 cm (108 inches×88 inches). Such aircraft often exhibit increased air resistance.

### SUMMARY

The invention is therefore based on the object of specifying an aircraft having an increased load volume for the transport of passengers and cargo with reduced air resistance. Furthermore, the invention is based on the object of indicating a cargo container which has an increased loading volume with an improved utilization of the cargo space of an aircraft. Furthermore, the invention has the further object of indicating a method by which loading and unloading of the cargo space of an aircraft is facilitated. The invention also has the further object of indicating a method which enables a quick and easy reconfiguration of an aircraft.

With respect to the cargo container, the first further object is solved by the subject matter of claim 15, with respect to the method for loading and unloading, the second further object is solved by the subject matter of claim 16, and with respect to the method for reconfiguration, the third further object is solved by the subject matter of claim 17. Advantageous arrangements result on the basis the sub-claims.

In particular, the object is solved by an aircraft for cargo and passenger transport having a fuselage extending longitudinally and having an upper deck, in particular the main deck, and a lower deck separated by a floor. The fuselage has a barrel section with a cross-sectional profile to accommodate cargo and/or passengers. The cross-sectional profile is formed by several, in particular four, circular arc sections which have radii with centers which differ from one another, so that the cross-sectional profile is designed in such a way that the upper deck and the lower deck can accommodate cargo items with different size dimensions, in particular cargo containers with different height and width dimensions.

A Cartesian coordinate system is assigned to the aircraft according to the invention in order to provide individual directional information. In this case, the x-axis extends from the rear of the aircraft to the nose of the aircraft, the y-axis is transverse to the x-axis and lies essentially in the plane spanned by the wings. The z-axis is perpendicular to the x- and y-axis. The longitudinal direction or x-direction of the aircraft extends parallel to the x-axis, a y-direction of the aircraft parallel to the y-axis and a z-direction parallel to the z-axis.

Within the scope of the following description, only the relevant variants of the above-described cargo items or containers and pallets are used as examples. In concrete terms, the contour and design of the respective cargo item will be considered.

The aircraft is preferably designed as a low-wing configuration. In the low-wing configuration, the wings are arranged in z-direction below the fuselage. The wing box of the aircraft is arranged in z-direction in the lower fuselage area, i.e. in the area of the lower deck. Alternatively, the aircraft can be designed as a mid-deck configuration. In the mid-deck configuration, the wings and thus the wing box are essentially arranged in z-direction in the center of the fuselage.

The invention has several advantages. Due to the different centers of the radii of the circular arc sections, a cross-sectional profile of the barrel section is made possible, which allows the upper and lower decks to be loaded with a variety of different standardized containers. Due to the cross-sectional profile, it is particularly advantageous to be able to transport at least one aircraft engine of one's own aircraft type. The cross-sectional profile is therefore preferably designed in such a way that at least one aircraft engine, in particular of the own aircraft type, and/or at least one motor vehicle can be brought into the upper deck for cargo transport. Preferably, the lower deck or cargo space and a loading door for cargo have a minimum usable clear height, in particular passage height, in z-direction of 269 cm to 290 cm (106 inches to 114 inches). The clear height is composed of a cargo system height, an engine pallet thickness and an engine rotor diameter. The cargo system height can be at least 3.2 cm to 5.1 cm (1.25 inches to 2 inches). The engine pallet thickness is preferably a maximum of 2.25 inches (5.7 cm). In addition, the engine rotor diameter can range from 247.4 cm to 266.4 cm (97.4 inches to 105 inches).

Due to the cross-sectional profile of the barrel section, the aircraft thus has an increased load volume. This increases the transport capacity, especially for aircraft in the application segment between narrow-body aircraft and wide-body aircraft.

The invention has the additional advantage that the staggered centers of the circular arc sections create a shape of the cross-sectional profile that has a reduced air resistance. This reduces CO₂ emissions. As a result, the aircraft according to the invention thus has a maximized load volume and a reduced air resistance.

The deviating centers of the radii of the circular arc sections can be offset from each other. The centers can be offset from each other in z-direction and/or in y-direction. In other words, the centers can be spaced from each other in z-direction and/or in y-direction. It is conceivable that the centers are spaced from each other on a common z-axis or on a common y-axis.

Regarding the deviating centers of the radii of the circular arc sections, two different embodiments of their arrangement are possible. In a (first) embodiment, the centers of the individual radii essentially form a common center area. The centers are slightly spaced from each other. Such a distance can be smaller or equal to 10 cm (4 inches).

In a (second) embodiment, the centers of the radii are spaced apart, so that the centers form individual centers. The distance between the centers, especially between at least two centers, can range from a minimum of 10 cm to a maximum of 63 cm (4 inches to 25 inches), and especially from a minimum of 25.5 cm to a maximum of 58 cm (10 inches to 23 inches). It is conceivable that the distance between the centers, especially between at least two centers, can be from 43 cm to 56 cm (16 inches to 22 inches). Alternatively or in addition, it is conceivable that the distance between the centers, especially at least two centers, may be from 15 cm to 16 cm (6 inches).

In an alternative embodiment of the aircraft according to the invention, the cross-sectional profile of the barrel section is circular. This embodiment, just like the embodiment already described, can be combined with all subsequent variants and/or embodiments and/or more precise designs. With the alternative embodiment, in other words, the cross-sectional profile of the barrel section can be formed by a single circle. The barrel section with circular cross-section has the advantage that it can be produced at low cost. Production is simplified in this case. In the context of the invention, the circular arc sections are not only considered one-dimensional, but also two-dimensional. The circular arc sections can each have an inner radius and an outer radius. In other words, the circular arc sections can each comprise a part of an aircraft outer skin. In this case, the circular arc sections have a wall thickness.

The cross-sectional profile can be constant over the entire length of the barrel section. The cross-sectional profile is preferably symmetrical in relation to the z-axis. It is conceivable that the fuselage is formed by a single barrel section which merges into an aircraft nose at a front end and into an aircraft tail at a rear end. Alternatively, it is conceivable that the fuselage is formed by several, in particular at least two, barrel sections which are adjacent to each other in the longitudinal direction.

The cross-sectional profile is preferably designed in such a way that at least one pallet, in particular a PMC and/or PAG pallet, having the basic dimensions of 243.8 cm by 317.5 cm (96 inches×125 inches) and/or 223.5 cm by 317.5 cm (88 inches×125 inches), can be accommodated in longitudinal loading for cargo transport into the lower deck. The PMC pallet has the basic dimensions of 243.8 cm×317.5 cm (96 inches×125 inches) and the PAG pallet has the basic dimensions of 223.5 cm×317.5 cm (88 inches×125 inches). In addition, the cross-sectional profile is preferably designed in such a way that at least one cargo container, in particular AKH and/or LD8-45, with a height of at least 114 cm to a maximum of 127 cm (45 inches to 50 inches), having the basic dimensions of 153.4 cm×156.2 cm (60.4 inches×61.5 inches) and/or with the basic dimensions of 153.4 cm×243.8 cm (60.4 inches×96 inches), can be accommodated for cargo transport on the lower deck. Alternatively, the lower deck cargo containers can be 162.5 cm (64 inches) high.

The cross-sectional profile can be designed in such a way that at least two cargo containers, in particular AAA, AAC, AAY, AAZ and/or AAJ or PAG pallets, with basic dimensions of 223.5 cm×317.5 cm (88 inches×125 inches), can be arranged next to each other in the y-direction for cargo transport on the upper deck.

Preferably, the cross-sectional profile is designed in such a way that at least two pallets, in particular PAG, HCU-12E and/or HCU-6E, having the basic dimensions of 223.5 cm×317.5 cm (88 inches×125 inches), 137.1 cm×223.5 cm (54 inches×88 inches) and/or 223.5 cm×274.3 cm (88 inches×108 inches), can be brought into the upper deck for cargo transport in longitudinal loading and/or transverse loading.

The cargo containers for the upper deck can be 223.5 cm (88 inches), 244 cm (96 inches) or 300 cm (118 inches) high. In addition or alternatively, the upper deck cargo containers can be 96 inches or 118 inches high.

As described above, the cross-sectional profile of the barrel section can be formed by a single circle. The cross-sectional profile of the barrel section can have an outer maximum width in the y-direction and an outer maximum height in the z-direction of at least 490 cm to 510 cm (193 inches to 201 inches). Preferably, the outer maximum width in y-direction and the outer maximum height in z-direction is between 495 cm and 500 cm (195 inches and 197 inches). Particularly preferably, the cross-sectional profile of the barrel section in the y-direction has an outer maximum width and an outer maximum height in the z-direction of 497 cm (196 inches). In other words, the cross-sectional profile has an outer radius of 497 cm (196 inches) divided by 2. This outer radius can vary by +/−0.5%, according to the invention. Alternatively or additionally, the cross-sectional profile or cargo space can have an inner diameter (=two times the inner radius) in the range between 472 cm (e.g. 186 inches) and 478 cm (e.g. 188 inches) and/or from 475 cm (187 inches)+/−1% or +/−0.7%. An inner diameter of approximately 472 cm (e.g. 186 inches) is preferred.

In a further embodiment, the cross-sectional profile of the barrel section can have an outer maximum width in the y-direction and an outer maximum height in the z-direction, in particular an outer diameter of at least 465 cm to a maximum of 485 cm (183 inches to 191 inches). Preferably, the outer maximum width in the y-direction and the outer maximum height in the z-direction, especially the outer diameter, is between 470 cm and 480 cm (185 inches and 189 inches). Preferably, the cross-sectional profile of the barrel section in the y-direction has an outer maximum width and an outer maximum height in the z-direction of approximately 477 cm (188 inches). In other words, the cross-sectional profile has an outer radius of approximately 477 cm (188 inches) divided by 2. Most preferably, the cross-sectional profile of the barrel section in the y-direction has an outer maximum width and an outer maximum height in the z-direction of 472 cm (186 inches). In other words, the cross-sectional profile has an outer radius of 472 cm (186 inches) divided by 2. The outer radii can vary by +/−0.5% according to the invention.

In general, it is pointed out that all measurements in cm may be subject to a tolerance of approx. +/−1 cm.

The advantage of this is that the production of the barrel section is simplified and a multiple use of fuselage parts, e.g. fuselage shells and/or fuselage segments is made possible. Costs are thus saved.

In one embodiment, the cross-sectional profile of the fuselage is formed oval, wherein the fuselage, in particular the barrel section, has an external maximum width of at least 490 cm to a maximum of 510 cm (193 inches to 201 inches) in the y-direction and an external maximum height of at least 480 cm to a maximum of 500 cm (189 inches to 197 inches) in the z-direction and/or an external maximum height of 440 cm to 450 cm (173 inches to 177 inches) in the z-direction. Preferably, the outer maximum width in the y-direction is between 495 cm and 500 cm (195 inches and 197 inches) and the outer maximum height in the z-direction is between 482.5 cm and 490 cm (190 inches and 193 inches) or the outer maximum height in the z-direction is between 442 cm and 447 cm (174 inches and 176 inches).

It is conceivable that the outer maximum width in y-direction is 497 cm (196 inches) and the outer maximum height in z-direction is 485 cm (191 inches) or the outer maximum height in z-direction is 447 cm (176 inches). This results in two preferred oval variations of the cross-sectional profile of the barrel section. In the first variant, the cross-sectional profile preferably has an outer maximum width of 497 cm (196 inches) in the y-direction and an outer maximum height of 485 cm (191 inches) in the z-direction.

In the first oval variant of the cross-sectional profile as well as in the circular variant of the cross-sectional profile, the upper deck (main deck) can be loaded with a large number of the containers and pallets usually used. In addition, containers, in particular AKH containers, having the basic dimensions of 153.4 cm×156.2 cm (60.4×61.5 inches), can be loaded on the lower deck in combination with pallets, in particular PAG and/or PMC pallets, having the basic dimensions of 223.5×317.5 cm (88×125 inches) and/or 243.8×317.5 cm (96×125 inches). Furthermore, containers, especially LD8-45 containers, having the basic dimensions of 243.8×153.4 cm (96×60.4 inches) and a height of 114.5 cm (45 inches), can be placed on the lower deck. The first oval variant of the cross-sectional profile, however, has an air resistance reduced by approx. 2% compared to the circular variant of the cross-sectional profile, as well as a reduced structural weight.

In a second oval variant, the cross-sectional profile preferably has an outer maximum width of 497 cm (196 inches) in the y-direction and an outer maximum height of approx. 447 cm (approx. 176 inches) in the z-direction. The second oval variant of the cross-sectional profile has a reduced air resistance of approx. 9% to 10% compared to the circular variant of the cross-sectional profile. Furthermore, the structural weight is further reduced.

In contrast to the circular as well as the first oval variant, the second oval variant of the cross-sectional profile does not allow pallets, in particular PAG and PMC pallets, having the basic dimensions of 223.5×317.5 cm (88×125 inches) and/or 243.8×317.5 cm (96×125 inches), to be placed in the lower deck. Here, only containers, especially AKH containers, having the basic dimensions of 153.4 cm×156.2 (60.4×61.5 inches), in combination with pallets, especially PKC pallets, having the basic dimensions of 153.4 cm×156.2 (60.4×61.5 inches), can be placed in the lower deck. In addition, mobile additional tanks with the basic dimensions of 153.4 cm×156.2 (60.4×61.5 inches) can be arranged in the area of a wing box and/or in the area of a landing gear.

Alternatively, the fuselage may have an outer maximum width of 501 cm (approx. 197 inches) in the y-direction and an outer maximum height of 447 cm (176 inches) in the z-direction. The fuselage also has an oval cross-sectional shape and thus represents a third oval variant.

In one embodiment, the fuselage, in particular the barrel section, has an outer maximum width of at least 490 cm to a maximum of 510 cm (193 inches to 201 inches) in the y-direction and an outer maximum height of at least 450 cm to a maximum of 470 cm (177 inches to 185 inches) in the z-direction. Preferably, the outer maximum width in the y-direction is between 495 cm and 500 cm (195 inches and 197 inches) and the outer maximum height in the z-direction is between 455 cm and 465 cm (179 inches and 183 inches). Preferably, in a fourth oval variant, the fuselage has an outer maximum width of 497 cm (196 inches) in the y-direction and an outer maximum height of 460 cm (181 inches) in the z-direction. Alternatively, the fuselage can have a maximum external height of 461 cm (181.5 inches) in the z-direction.

The circular variant of the fuselage with an outer diameter of 497 cm (196 inches) as well as the four oval variants of the fuselage preferably refer to an aircraft in which the aircraft engines are located below on the wings. A low-wing configuration of the aircraft is particularly advantageous. The other circular variants of the fuselage with the outer diameters of approx. 477 cm (188 inches) and 472 cm (186 inches) preferably refer to an aircraft in which the aircraft engines are located at the rear of the aircraft and not below the wings. The aircraft is generally designed in a low-wing configuration, which is particularly advantageous.

The outer maximum width and the outer maximum height may have a dimensional tolerance of +/−5%, in particular a dimensional tolerance of less than +2%%, in particular a dimensional tolerance of +/−0.5%. In other words, the outer maximum width and height can vary in the range of +/−5%, preferably in the range of +/−0.5%.

Due to the special oval shape of the fuselage, a plurality of the above-mentioned standardized containers can be placed in the upper and lower decks. Furthermore, in the upper deck, if the aircraft has a cargo configuration, i.e. without passenger seating in the upper deck, it is possible to transport the aircraft's own engine type as well as large vehicles. In a passenger transport configuration of the aircraft, i.e. with passenger seating in the upper deck, this allows, for example, seven-row seating with two longitudinal aisles. The aircraft can thus be used for a variety of purposes, wherein the aircraft always has an increased load volume.

In another particularly preferred embodiment, the fuselage has a first clear width in the y-direction, in particular an inner maximum width, of at least 460 cm to a maximum of 480 cm (181 inches to 189 inches) and a second clear width in the z-direction, in particular an inner maximum height, of at least 450 cm to a maximum of 480 cm (177 inches to 189 inches). Preferably, the first clear width is between 465 cm and 475 cm (183 inches and 187 inches) and the second clear width is between 455 cm and 475 cm (179 inches and 187 inches). It is conceivable that the first clear width is 472.5 cm (186 inches) and the second clear width is 460 cm (181 inches). Preferably, the fuselage has an outer maximum height in the z-direction of 485 cm (191 inches) and an inner maximum height, especially a second clear width, of 460 cm (181 inches). Further preferably, the fuselage has an outer maximum width in the y-direction of 497 cm (196 inches) and an inner maximum width, especially the first clear width, of 472.5 cm (186 inches).

The fuselage or barrel section can have a wall thickness of the fuselage outer skin of 10 cm to 13 cm (4 inches to 5 inches). The two clear widths can have a dimensional tolerance of +/−5%, especially a dimensional tolerance of less than +2%, especially a dimensional tolerance of +1-1% or +/−0.7%. In other words, the clear widths can vary in the range of +/−5%, preferably in the range of +/−1% or +/−0.7%. This dimensional tolerance also applies to the wall thickness of the fuselage outer skin.

With an outer maximum width of 501 cm (approx. 197 inches) in the y-direction and a maximum height of 447 cm (176 inches) of the fuselage in the z-direction, the first clear width, in particular the inner maximum width, is therefore from 474 cm to 480 cm (187 inches to 189 inches) and the second clear width, in particular an inner maximum height, is from 421 cm to 427 cm (166 inches to 168 inches).

With a maximum outer width of 497 cm (196 inches) in the y-direction and a maximum height of 460 cm (181 inches) in the z-direction of the fuselage, the first clear width is approximately 471 cm to 477 cm (186 inches to 188 inches) and the second clear width is 434 cm to 440 cm (171 inches to 173 inches). Alternatively, the fuselage can have an outer maximum height of 461 cm (181.5 inches) in the z-direction and thus a second clear width of 435 cm to 441 cm (171.5 inches to 173.5 inches).

With a maximum outer width of 497 cm (196 inches) in the y-direction and a maximum height of 497 cm (196 inches) of the fuselage in the z-direction, the first and second clear widths are from approximately 471 cm to 477 cm (186 inches to 188 inches). In other words, the fuselage has an outer diameter of 497 cm (497 inches), the inner diameter of the fuselage is approximately 471 cm to 477 cm (186 inches to 188 inches).

The above embodiments in relation to the first and second clear widths preferably concern an aircraft in which the aircraft engines are located below on the wings.

With an outer diameter of the fuselage of approximately 477 cm (188 inches), the inner diameter of the fuselage is approximately 452 cm to 457 cm (178 inches to 180 inches). With an outside diameter of the fuselage of approximately 472 cm (186 inches), the inner diameter of the fuselage is approximately 446 cm to 452 cm (176 inches to 178 inches). These two embodiments preferably relate to an aircraft in which the aircraft engines are located at the tail of the aircraft, i.e. not at the wings.

Due to the preferred clear widths of the barrel section of the fuselage, the aforementioned standardized containers as well as aircraft engine types and large vehicles can be transported simultaneously. The aircraft has the advantage of an improved or increased cargo volume in the cargo and passenger transport configuration.

The cross-sectional profile can be designed such that the upper deck has a clear width, in particular height, in the z-direction of at least 280 cm to a maximum of 300 cm (approx. 110 inches to approx. 118 inches), in particular of at least 285 cm to 290 cm (approx. 112 inches to approx. 114 inches). Preferably, the upper deck in the barrel section has a clear width of 288 cm (approx. 113.5 inches) in the z-direction.

The cross-sectional profile can be designed such that the upper deck has a clear width, in particular height, in the z-direction of at least 254 cm to a maximum of 287 cm (100 inches to 113 inches), in particular of at least 264 cm to 273 cm (104 inches to 107 inches). Preferably, the upper deck in the barrel section has a clear width of 267 cm (105.75 inches) in the z-direction. Alternatively, the upper deck in the barrel section in the z-direction can have a clear width of approx. 274 cm (approx. 108 inches). Further alternatively, it is conceivable that the upper deck in barrel section 1 can have a clear width of 284.75 cm (112.5 inches) in the z-direction. This clear width, especially the height, is measured from an upper edge of the floor in the z-direction. It is advantageous that cuboid containers, in particular AMA containers, with dimensions of 243.8×317.5×243.8 cm (96×125×96 inches) can be arranged on the upper deck (main deck). In addition, aircraft engines with an engine rotor diameter of, for example, approx. 239 cm (approx. 94 inches), approx. 247 cm (97.4 inches) and/or approx. 267 cm (105 inches) can advantageously be placed on the upper deck.

In another particularly preferred embodiment, the cross-sectional profile is formed by at least four circular arc sections, wherein a first circular arc section at least partially spans the upper deck, a second circular arc section delimits the lower deck and two third circular arc sections are arranged opposite each other between the first and second circular arc sections. The two third circular arc sections are arranged mirror-symmetrically with respect to the z-axis. The two third circular arc sections are adjacent to the first and second circular arc sections. Together, the at least four circular arc sections form a closed contour that forms the cross-sectional profile of the barrel section. In general, it is conceivable that the cross-sectional profile is formed alternatively by less than four circular arc sections or by exactly four circular arc sections.

The barrel section or fuselage can be made of four partial barrel segments, wherein each partial barrel segment has one of the four circular arc sections and extends in the longitudinal direction of the barrel section. This has the advantage that the barrel section has a modular structure, which simplifies the production and configuration of the barrel section and fuselage. Furthermore, it is advantageous that a variety of variants of the aircraft is increased, since it is possible to provide at least one row of windows in the partial barrel segments with the third circular arc sections for the passenger transport configuration of the aircraft or windowless partial barrel segments for the cargo configuration of the aircraft. Advantageously, the aircraft can thus be configured individually according to the application.

Preferably, the third circular arc sections are designed in such a way that they have a height of 80 cm to 120 cm (32 inches to 47 inches) in the z-direction, in particular of approx. 104 cm (41 inches). The height is measured starting from a height position of the centers of the third circular arc sections in z-direction. In other words, the centers of the third circular arc sections are spaced from the top edge of the floor in the z-direction, with the height of the third circular arc sections extending in the z-direction from the heights of their centers. Starting from the top edge of the floor, the third circular arc sections, in particular the partial barrel segments, can have a height in the z-direction of approx. 140 cm to approx. 170 cm (approx. 55 inches to approx. 67 inches). Preferably, the third circular arc sections in the z-direction from the top edge of the floor have a height of approx. 162 cm (approx. 64 inches).

Alternatively, the third circular arc sections can extend from 62 cm to 142 cm (approx. 24.5 inches to 56 inches) in height in relation to the top edge of the floor in the z-direction, in particular from 89 cm to 127 cm (35 inches to 50 inches). In other words, the third circular arc sections can end with a top end in the z-direction between 62 cm and 142 cm (about 24.5 inches to 56 inches), especially from 89 cm to 127 cm (35 inches to 50 inches), above the top edge of the floor. This results in a straight segment length of approximately 38 cm to 80 cm (15 inches to approx. 31.5 inches).

This enables the arrangement of a row of windows in the third circular arc sections, since conventional windows have a height of approx. 45 cm to approx. 48 cm (18 inches to 19 inches). Furthermore, in the passenger configuration of the aircraft, a passenger sitting in the row of windows has sufficient space without being cramped at the sides. In the cargo configuration of the aircraft, this allows for the juxtaposition of two standard cargo containers, especially AAJ and/or AAC, having the basic dimensions of 223.5 cm by 317.5 cm (88 inches×125 inches) in the upper deck in the y-direction. The aircraft thus has an increased cargo volume.

More preferably, the centers of the first and second circular arc sections are located on a common z-axis of the aircraft, with the center of the second circular arc section being offset upward from the center of the first circular arc section.

Specifically, the center of the second circular arc section is offset upward in the z-direction from the center of the first circular arc section. This gives the fuselage an advantageous improved shape.

In a preferred embodiment, the centers of the two third circular arc sections lie on a common y-axis, in particular at the same level, with the two centers being offset in opposite directions with respect to the z-axis. The common y-axis may be spaced from the y-axis of the aircraft from the upper edge of the floor in the z-direction, especially upwards. In other words, the centers of the third circular arc sections are spaced from the z-axis in the opposite direction. The distance from the z-axis to the respective center of the third circular arc sections can be between 4 cm and 35 cm (2 inches and approx. 14 inches). Alternatively, the distance from the z-axis to the respective center of the third circular arc sections can be between 7.5 cm and 15 cm (3 inches and 6 inches). The distance from the z-axis to the respective center of the third circular arc sections can also be essentially 9 cm (approx. 3.5 inches). Alternatively, it is conceivable that the distance from the z-axis to the respective center of the third circular arc sections is approximately 27.5 cm (approx. 10.75 inches).

In one embodiment, the distance between the two centers of the third circular arc sections in the y-direction can be from 48 cm to 120 cm (19 inches to 47 inches), and in particular from 52 cm to 118 cm (20.5 inches to 46.5 inches). More specifically, the distance between the two centers of the third circular arc sections in the y-direction can be from 50 cm to 60 cm (approx. 19.5 inches to approx. 23.5 inches), preferably 54.5 cm (21.5 inches), or from 85 cm to 118 cm (33.5 inches to 46.5 inches). The distance between the two centers of the third circular arc sections in the y-direction can be 91 cm (36 inches) or 116 cm (approx. 45.8 inches)

Preferably, the first circular arc section has a radius R1 and the second circular arc section has a radius R2, wherein the radius R1 is smaller than the radius R2. Preferably, the third circular arc section has an equal radius R3, which is smaller than the radii R1, R2. The radius R1 can be 252 cm (99 inches), the radius R2 can be 249 cm (98 inches) and the radius R3 can be 226 cm (89 inches). The radii R1, R2, R3 are preferably the outer radii of the circular arc sections.

In a particularly preferred embodiment, the lower deck is formed continuously in the longitudinal direction of the fuselage, wherein the lower deck has a forward cargo space, an aft cargo space and, in the area of the wing box, a through-loading space connecting the forward cargo space and the aft cargo space. Preferably, the lower deck is designed to be continuous in the longitudinal direction of the fuselage so that in the area of a wing box and/or in the area of a landing gear at least one mobile additional tank and/or at least one pallet, in particular PAG and/or PMC pallet, can be accommodated. In other words, the mobile additional tank can be inserted or removed as required in the through-loading space in the area of the wing box and/or in the area of the landing gear.

The pallet can have the basic dimensions or base area of 243.8 cm×317.5 cm (96 inches×125 inches) or 223.5 cm×317.5 cm (88 inches×125 inches) or 223.5 cm×274 cm (88 inches×108 inches). The height of the pallet can range from 102 cm to 127 cm (40 inches to 50 inches), and in particular 114.5 cm (45 inches). The mobile auxiliary tank can have a volume for fuel, especially kerosene, of approximately 8800 liters. It is advantageous here that the through-loading space allows loading of the lower deck from a loading opening. This saves loading openings and loading doors and thus reduces weight and costs.

Due to the through-loading space, there is no need for a permanently embedded central tank for fuel in the area of the wing box and the landing gear. It is generally known that the fuel in the central tank is often only used to improve weight distribution in the aircraft. This is particularly disadvantageous for short and medium-haul flights, as the unused fuel in the central tank increases the weight of the aircraft. The central tank is no longer required due to the through-loading space, which saves weight and costs and reduces maintenance requirements. In order to be able to provide an increased amount of fuel for long-haul flights, for example, the mobile additional tanks can be accommodated in the cargo space. The auxiliary tanks can each have the basic dimensions of 243.8 cm×317.5 cm (96 inches×125 inches) with a height of 114.5 cm to 127 cm (45 inches to 50 inches).

The aircraft may have at least one landing gear which is located at the nose of the aircraft and is adjustable in height when extended. Due to the height-adjustable landing gear, the fuselage can be tilted towards the rear when loading the lower deck, so that the cargo items, in particular cargo containers, are automatically loaded through the weight force by the inclination from the forward cargo space through the through-loading space into the aft cargo space or the through-loading of the cargo is at least supported by gravity. Likewise, the fuselage can be tilted towards the nose by the height-adjustable landing gear in order to unload the cargo or cargo containers by the force of gravity independently or supported by gravity. The advantage of this is that loading and unloading of the aircraft is made easier. Furthermore, the complexity of the cargo space can be reduced.

In another particularly preferred embodiment, the through-loading space in the area of the wing box or landing gear is designed in such a way that cargo containers can be loaded through from the nose and/or tail of the aircraft when the lower deck is loaded. This simplifies loading and unloading of the lower deck.

Particularly preferably, the through-loading space has a minimum width in the y-direction of the aircraft of at least 240 cm to a maximum of 270 cm (94.5 inches to 106.5 inches), in particular of at least 250 cm to a maximum of 260 cm (98.5 inches to 102.5 inches). Alternatively, the through-loading space may have a minimum width in the y-direction of 244 cm (96 inches). The through-loading space can have a clear width in the y-direction of 254 cm (100 inches). Preferably, the through-loading space has a through-loading height of at least 124.5 cm (49 inches), in particular 124 cm (approx. 49 inches). The cross-section of the through-loading space is preferably rectangular. This has the advantage that, for example, when PMC pallets with a width of 243.8 cm (96 inches) and a height of 114 cm (45 inches) are arranged, a circumferential distance of approx. 5 cm (2 inches) is provided and thus optimum freedom of movement is achieved when loading and unloading the pallets. The above-mentioned dimensions of the through-loading space preferably concern the through-loading space of an aircraft where the aircraft engines are located below the wings.

Alternatively, it is conceivable that the through-loading space has a minimum width in the y-direction of the aircraft of at least 156 cm (approx. 61.5 inches).

The dimensions of the through-loading space differ in the design variant of the aircraft with the aircraft engines at the rear of the aircraft and not under the wings. Preferably, the through-loading space has a minimum width, especially clear through-loading width, in the y-direction of the aircraft of 300 cm to 360 cm (118 inches to 142 inches), in particular 310 cm to 350 cm (122 inches to 138 inches), in particular 320 cm to 340 cm (126 inches to 134 inches). Especially preferably, the through-loading space has a minimum width in y-direction of 328 cm (129 inches). Preferably, the through-loading space has a minimum height, in particular clear through-loading height, in the z-direction of the aircraft of 150 cm to 190 cm (59 inches to 75 inches), in particular 160 cm to 180 cm (63 inches to 71 inches). Particularly preferably, the through-loading space has a minimum height in the z-direction of 173 cm (68 inches). The minimum height is essentially measured from a floor structure, which preferably has a roller conveyor system for loading the lower deck and securing the cargo items, to a lower edge of the floor separating the lower deck from the upper deck.

The through-loading space preferably has a rectangular cross-section, which is sloped towards the floor in the longitudinal direction of the aircraft, especially in the x-direction. In other words, the cross-section combines a rectangular and a trapezoidal shape. The through-loading space preferably essentially reproduces the cross-sectional shape of LD containers, in particular LD8 containers.

The aircraft in the variant with the aircraft engines at the tail has a lower deck which is higher in z-direction than the aircraft in the variant with the aircraft engines below at the wings. This allows the aircraft to be configured for passenger transport on the lower deck. In contrast, the aircraft variant with the engines below the wings has a higher upper deck in z-direction and can therefore accommodate larger or higher containers in the cargo configuration in z-direction.

In the y-direction, the landing gears can have a distance between their axes of rotation of 956.6 cm (376 inches). It is advantageous here that cargo items and/or mobile auxiliary tanks with a width of 244 cm (96 inches) can be arranged or loaded through in the through-loading space. Preferably, only cuboidal cargo containers with a width of 244 cm (96 inches) can be placed or loaded through the through-loading space. In contrast to generally known aircrafts, the two landing gears of the aircraft according to the invention can be offset outwards in opposite y-direction to allow a correspondingly wide through-loading space.

The landing gear has two landing gear legs on either side of the fuselage in the y-direction, with wheels on each leg. In a preferred embodiment, the landing gear legs are inclined backwards in x-direction of the aircraft when folded out. In other words, when folded out, the landing gear legs have an angle so that the landing gear legs extend diagonally backwards. The angle is spanned between a z-axis of the aircraft, which intersects the axis of rotation of the landing gear, and a longitudinal axis of the landing gear legs. The angle can preferably be between a minimum of 5° and a maximum of 30°. Alternatively, the angle can be a minimum of 10° up to a maximum of 20°.

The landing gear legs are preferably arranged in such a way that they extend diagonally to the rear when folded. This has the advantage that in the folded state a required width of the through-loading space can be achieved in order to arrange possible mobile additional tanks and/or PMC pallets in the through-loading space.

In a preferred embodiment, the lower deck in the barrel section has a through-loading height of at least 140 cm (55 inches), in particular at least 127 cm (50 inches) at least in sections. Preferably, the lower deck in the barrel section may have a through-loading height of at least 122.5 (48.25 inches) or at least 124.5 cm (49 inches). Through-loading height is essentially measured from a floor structure, preferably including a roller conveyor system for loading the lower deck and securing the cargo items, to a lower edge of the floor separating the lower deck from the upper deck. In other words, the loading height corresponds to a clear width, especially height, in the z-direction of the lower deck. The through-loading height can be essentially constant throughout the entire barrel section. It is advantageous that cargo containers with a height of approx. 114 cm (45 inches) can be introduced into the lower deck.

In one embodiment, the lower deck in the barrel section has a clear, particularly usable, height from a central aisle floor to a lower edge of the floor separating the two decks, from 185 cm to 215 cm (73 inches to 85 inches), in particular from 185 cm to 208 cm (73 inches to 82 inches). Preferably, the clear height from the center aisle floor to the lower edge of the floor separating the two decks is 185 cm to 201 cm (73 inches to 79 inches). The central aisle floor of the lower deck is the accessible, especially central, area between two rows of seats. Furthermore, the central aisle floor is preferably offset downwards in the z-direction with respect to the side rows of seats, in particular it is recessed to provide the required standing height for passengers.

In the cargo configuration, the lower deck of this embodiment provides the necessary height to accommodate a standard container, such as an LD-8 container having a height of 162.5 cm (64 inches).

Preferably, the upper deck is designed in such a way that a maximum of seven rows of seats can be inserted for passenger transport, wherein in the inserted state at least two aisles extend in the longitudinal direction, in particular in the x-direction, between the rows of seats. The rows of seats extend in the longitudinal direction of the aircraft. Seating in 2-3-2 configuration in the upper deck is preferably provided. This may apply to the economy area. In addition, seating in 1-2-1 configuration is conceivable, e.g. for the business area and/or seating in 2-2-2 configuration, e.g. for the premium economy area. The aisles can each have a width in y-direction between the adjacent rows of seats of 38 cm to 65 cm (15 inches to 25.6 inches). Preferably, the aisles each have a width in the y-direction between the adjacent rows of seats of approx. 52 cm (approx. 20.5 inches).

In a preferred embodiment, at least one galley area and at least one sanitary area are provided, wherein the galley area is arranged at one end of the fuselage and the sanitary area is arranged at a distance from the galley area in longitudinal direction towards the fuselage center. This has the advantage that passengers who want to use the sanitary area do not have to walk through the galley area or do not stand in the galley area while the passengers wait in front of the sanitary area. This improves freedom of movement for passengers and aircraft personnel.

Preferably, the galley area comprises at least one receiving device, in particular a galley ring, for accommodating cargo items, in particular galley utensils and/or luggage, which is of annular design in the fuselage and extends at least partially through the two decks. Such a receiving device is known from EP 2 602 187 B1, which is from the applicant.

Preferably, at least one first loading door for loading and unloading the upper deck and/or at least one second loading door for loading and unloading the lower deck are arranged. The first loading door of the upper deck is only used in the cargo configuration or a combination configuration of the aircraft in which passengers and cargo are transported in the upper deck. The first loading door and/or the second loading door may be located in the barrel section. The advantage of placing the first loading door of the upper deck in the barrel section is that if the aircraft is stretched or shrunk, the loading door or barrel section is not affected, thus maintaining standardized sections of the complex structural sections of the aircraft. This concerns for example the nose, the tail or the wing box area.

Preferably, the first loading door is located in the nose area and the second loading door in the tail area or the second loading door is located in the nose area and the first loading door in the tail area on opposite sides of the aircraft.

Preferably, the lower deck comprises two loading doors, wherein the forward loading door provides access to the forward cargo space and the aft loading door to the aft cargo space for loading and unloading. The forward loading door closes a forward loading opening which is larger than an aft loading opening of the aft cargo space. Usually pallets are loaded through the forward loading door and containers through the aft loading door. This has the advantage that the pallets can be loaded early in the front and thus tail-tipping is avoided. Loading the containers in the aft cargo space has the advantage that “last-minute passenger suitcases” can still be loaded without having to consider “tail-tipping”.

The forward loading opening can have a clear width of at least approximately 332.5 cm (131 inches). Alternatively, the forward loading opening may have a minimum clear width of 259 cm (102 inches). In addition, the aft loading opening may have a minimum clear width of 168 cm (66 inches). The forward loading opening and/or the aft loading opening may have a clear height of at least 124.5 cm (49 inches) or 137 cm (54 inches). It is particularly advantageous that the lower deck has only one loading door for loading and unloading, which closes a forward loading opening. This has the advantage of saving weight and costs by eliminating the need for additional loading doors.

In the embodiment variant of the aircraft with the aircraft engines under the wings and in the cargo configuration of the aircraft, the lower deck preferably has at least one loading opening with a clear height of 124.5 cm (49 inches). In addition, another loading opening for loading and unloading the upper deck is preferably provided. Preferably, the further loading opening is located at the rear upper left, i.e. longitudinally at the rear, especially in front of the aircraft tail, in z-direction in the area of the upper deck and in y-direction on the left side of the aircraft. The loading opening of the lower deck, as seen from the rear of the aircraft, is particularly preferably formed in the front longitudinal direction, especially near the aircraft nose, in the z-direction in the area of the lower deck and in the y-direction on the right side of the aircraft. Advantageously, this allows simultaneous loading of both decks without causing tail-tipping.

In the embodiment variant of the aircraft with the aircraft engines at the tail of the aircraft, especially not under the wings, the lower deck preferably has at least one loading opening with a clear height of 172 cm (68 inches). In addition, another loading opening for loading and unloading the upper deck is preferably provided here, which is located in the upper left front. In other words, the further loading opening of the upper deck, as seen from the tail of the aircraft, is located longitudinally at the front, especially near the aircraft nose, in the z-direction in the area of the upper deck and in the y-direction on the left side of the aircraft. In addition, the loading opening of the lower deck, as seen from the tail of the aircraft, is preferably formed in the longitudinal direction at the rear, especially near the tail of the aircraft, in the z-direction in the area of the lower deck and in the y-direction on the left side of the aircraft. This variant also prevents “tail-tipping” by loading the decks simultaneously. An advantage here is the left-sided arrangement of the loading openings, as this prevents damage to the “tailing edge” flaps of the aircraft by hitting a loading and unloading vehicle, especially with the driver's cab. A high-loader can be used as a loading and unloading vehicle.

More preferably, the fuselage has a fuselage structure with a plurality of frames spaced apart in the x-direction, with the distance between adjacent frames being 53 cm or 64 cm (21 inches or 25.2 inches). This has the advantage that the decks can be loaded with pallets with a standard dimension of 317.5 cm (125 inches) in length and a bolt gap of 2.5 cm (1 inch).

In one embodiment, at least one tread cup is provided with a tread area of the lower deck, wherein the at least one tread cup is arranged in at least one side section of a bottom of the lower deck. The tread area may be designed in such a way that it is substantially parallel to the horizontal section of the floor. In one embodiment, the tread cups are integrated in one piece into the respective side section. In a preferred embodiment, at least one cargo space module is arranged in the lower deck to reinforce the fuselage structure of the fuselage and to support the floor. The aircraft may be free of vertical reinforcement struts. The advantage of this is that the lower deck does not have any reinforcing struts permanently installed on the sides, so that the volume of the lower deck can be better utilized for cargo arrangement.

In one embodiment, the through-loading space has a continuous through-loading cross-section which is smaller than a continuous cargo space cross-section of the forward and aft cargo space. The through-loading cross-section of the through-loading space, which is narrower in relation to the forward and aft cargo spaces, is due to the landing gear, which occupies space on both sides of the fuselage when folded. In other words, the landing gears protrude from the outside into the fuselage from the side when folded, so that the cross-section of the through-loading space is smaller than that of the forward and aft cargo space. This allows stowing of the landing gears during flight operations, while at the same time the through-loading space is designed for loading cargo from the nose or tail side or for placing mobile auxiliary tanks. The narrowed through-loading space is possible, for example, in aircraft whose engines are located below the wings. This is especially true for aircraft in low-wing configuration. Other configurations are possible.

In one embodiment which is alternative thereto, the through-loading space forms a common, continuous cargo space with the front and aft cargo spaces with a substantially constant cargo space cross-section. In other words, the lower deck has a cargo space cross-section that is constant between the nose and tail of the aircraft. This has the great advantage that loading of the lower deck can be carried out completely from one side of the cargo space, especially from the tail or nose of the aircraft. This makes it possible that only one cargo space door has to be provided, which is preferably located at the rear. The continuous cargo space is preferably possible in aircraft with short landing gear legs, i.e. the landing gear only takes up a small area on the side of the fuselage when folded, so that the cargo space cross-section can be the same throughout. This is especially possible in aircraft where the aircraft engines are located at the rear of the aircraft, i.e. the engines are not located at the wings. This is the case for aircraft in low-wing configuration. Other configurations are possible.

In one embodiment, several plates and/or beams are provided in the area of the wings, extending transversely to the longitudinal direction of the aircraft, which are spaced from each other in the longitudinal direction of the aircraft and are connected to a fuselage structure, in particular frames, of the aircraft. The plates may be essentially flat elements extending from one side of the aircraft to the opposite side of the aircraft, preferably continuously. In at least one exemplary embodiment, the cross-section of the plates or beams encloses or surrounds the loading area. The plates or beams can be designed at least partially as fiber composite material. They can have a C-shaped design in cross-section—transverse to the x-direction of the aircraft—at least in sections.

The plates can have a component structure with several T- or I-shaped webs that are connected to each other. For this purpose, at least one connecting web can be arranged between the webs to stiffen the component structure. In other words, the plates can have a large number of webs that form a component structure. The webs are connected to each other at least in sections. Between the webs, flat elements can be arranged which are thinner in thickness than the webs themselves. The webs can be formed integrally with each other. Alternatively or additionally, the webs can be riveted together. Other connection variants are possible.

In addition, the plates can have structural beams for further stiffening. These can be arranged in z-direction and/or in y-direction in the plane of the plate.

The plates may each have an at least partially circumferential collar. The collar can be part of at least one web. Preferably, the plates have a completely circumferential collar. The plates can each be formed by a milled part and/or a composite structure part. Alternatively or in addition, it is possible that the plates are each formed by a rivet construction.

The plates have flat depressions in the direction of the thickness, especially milling grooves. This has the advantage that weight is saved. The flat depressions can be formed on the plates on two opposite sides. The flat depressions can be formed in the longitudinal direction of the aircraft. The flat depressions are offset in relation to the collar in the thickness direction towards the center of the plate. In other words, the collar protrudes at right angles to the plate, especially in the longitudinal direction of the aircraft. The collar can protrude on both sides of the plate transversely to the extension of the plate.

The plates preferably have a plate thickness of 5 cm to 6.5 cm (2 inches to approx. 2.5 inches) each. Preferably, the collar can have a width of 5 cm to 6.5 cm (2 inches to approx. 2.5 inches) transversely to the plate extension.

The plates are preferably firmly attached to the frames of the aircraft. In one embodiment, the frames can be an integral part of the plates or beams, at least in sections. In one embodiment, the plates or beams extend at least in sections parallel to the cargo floor of the cargo space. This results in a reinforcing structure which extends from one side of the aircraft to the other side of the aircraft and absorbs the forces acting on the wings.

One of the plates can be arranged behind or in front of a frame in the longitudinal direction of the aircraft and firmly connected to it. The plates can also be arranged at the position of the frames. The plates can be connected to the fuselage structure, in particular to the frames, with a materially bonded and/or form-fit and/or frictional connection. The plates can be formed integrally with the fuselage structure. As already explained, the plates can be formed integrally with the frames. In other words, the plates and the frames can be formed integrally with the fuselage structure. The plates are preferably formed rigidly. Furthermore, the plates can be formed integrally with the fuselage structure. The plates make the wing box particularly rigid in the y-direction. Furthermore, such a plate construction enables a particularly light and stable construction of the wing box with the appropriate choice of material. An air gap can be provided between the plates, which extends parallel to the plates transversely to the longitudinal direction of the aircraft.

Due to the very rigid wing box structure, any additional tanks are preferably located in the wing box area. In the wing box area, the minimum requirements for the attachment of the additional tanks can be implemented more effectively. The minimum requirements refer to 9G (9-fold g-force) in longitudinal direction of the aircraft and 3G (3-fold g-force) in y-direction of the aircraft.

Further preferably, the plates or beams form at least one mounting stub for one wing each, in which the plates extend transversely to the longitudinal direction of the aircraft beyond the outer fuselage skin of the aircraft. In other words, the plates protrude with their plate ends in the y-direction over the fuselage area, so that the wings can be slid onto the plate ends. The plate ends protruding on one transverse side of the fuselage together form a mounting stub for a wing. Since the plates preferably project on both sides of the fuselage skin, they form two opposite mounting stubs for the wings. The wings are preferably attached to the mounting stubs. Via the mounting stubs, forces occurring on the wings or through the wings can be directly introduced into the wing box structure. Through the plates, pull and thrust forces can be absorbed particularly well and introduced into the fuselage structure. Furthermore, this embodiment has the advantage that the plates, which extend across the wing box, protrude into the wings with their plate ends. This creates an interlocking transition between the wings and the wing box, thus relieving the load on the connecting area of the wings on the fuselage. The fan-shaped engagement of the plate ends in the wings considerably improves power transmission.

In one embodiment, the plates each have at least one passage opening formed in the longitudinal direction of the aircraft, through which the through-loading space passes. In other words, the plates have at least one recess in the area of the cargo space of the lower deck in the longitudinal direction of the aircraft for the through-loading space. The plates are preferably arranged one behind the other in the longitudinal direction of the aircraft in such a way that the passage openings of the same size are aligned. The passage openings of the plates thus form a common passage in the longitudinal direction of the aircraft through the wing box and in the area of the landing gear. The through-loading space is enclosed at least in sections by the very stable wing box structure.

The passage openings preferably limit the through-loading space in y-direction at least partially circumferentially. In other words, the passage openings essentially reproduce the cross-sectional contour of the through-loading space. The passage openings can have a rectangular and/or trapezoidal cross-sectional shape in the longitudinal direction of the aircraft. Other cross-sectional shapes are possible.

In another preferred embodiment, the wing box has several crossbeams extending in y-direction, which are arranged above the plates in z-direction and interact with the plates to stiffen the fuselage structure. In other words, the crossbeams preferably form the part of the cross-stiffening structure that is on top in z-direction. Compared to crossbeams of the fuselage structure, which are arranged outside the wing box in longitudinal direction of the aircraft, the crossbeams are reinforced to absorb increased forces. The crossbeams of the wing box are preferably connected to the plates in a force-transmitting manner. Together with the plates, the crossbeams form a particularly stable stiffening unit, so that the stability of the wing box is further increased. In particular, the crossbeams stiffen the fuselage structure in y-direction, especially in the wing area. The crossbeams support the frames in the y-direction in the wing area, so that not only the stability of the wing box is stiffened, but also the stability of the entire barrel section in the wing area.

Preferably, the wing box has several longitudinal beams extending in the longitudinal direction of the aircraft, which connect the crossbeams to each other. The longitudinal beams preferably connect the crossbeams to each other in the longitudinal direction of the aircraft. Together with the crossbeams, the longitudinal beams form a grid structure that is arranged above the plates essentially in the z-direction. In the longitudinal direction of the aircraft, the longitudinal beams are preferably arranged in the wing box area and in the area of the landing gear. The longitudinal beams stiffen the fuselage structure, especially the wing box, in the longitudinal direction of the aircraft. In the longitudinal direction of the aircraft, the longitudinal beams can extend beyond the wing box or the landing gears to further increase stability. Overall, the wing box with the plates and the crossbeams and longitudinal beams forms a very stable structure, which is the stiffest part of the fuselage structure.

Seat rails for fastening passenger seats or cargo are particularly preferred above the longitudinal beams in the z-direction of the aircraft. Since the wing box, especially in the area of the wings, forms the stiffest part of the fuselage structure, at least one joint is preferably arranged in a transition area between the wing box and adjoining further barrel sections of the aircraft, which connects the seat rails in the wing box area to the seat rails of the adjoining barrel sections in an articulated manner. In the transition area, movable seat rail pieces can be arranged, which connect the seat rails of the adjoining barrel sections to the seat rails in the wing box area. The barrel sections adjoining the wing box area preferably have further longitudinal beams extending in the longitudinal direction of the aircraft on which the further seat rails run. The longitudinal beams of the adjoining barrel sections are preferably firmly connected to the aircraft structure, in particular the frames and the outer skin of the fuselage. The movable seat rail sections are preferably adapted to compensate for the vertical deformation of the longitudinal beams under load relative to the stiff wing box. Under load, e.g. in flight, the transition area forms the area of maximum fuselage bending. This has the advantage that, for example in flight operations, the barrel sections, which are more flexible than the wing box area, can deform or bend accordingly without causing damage in the transition area between the flexible and rigid barrel sections.

In general, it is possible that the longitudinal beams have a certain degree of flexibility or maneuverability in relation to the other barrel sections of the aircraft. In this way, an optimally adjusted deformability of the fuselage is achieved.

In one preferred embodiment, the wings of the aircraft are angled in z-direction. In other words, the wings of the aircraft have a kink in the z-direction in this embodiment. Preferably, the wings have a larger angle of inclination from the fuselage than towards a free wing tip of the wings, relative to a reference axis running in y-direction. In other words, the wings extend in y-direction starting from the fuselage first with an angle of inclination which is steeper than an angle of inclination towards the wing ends. This applies preferably to aircraft in low-wing configuration. Starting from a lower fuselage area in z-direction, the wings extend laterally outwards. In an area close to the fuselage, the angle of inclination of the respective wing course is larger than in an area far away from the fuselage.

The angle of inclination is defined as the angle that increases in z-direction from the fuselage to the free wing tip.

In the area close to the fuselage, the wings can have an angle of inclination relative to the reference axis of between 12 and 22 degrees, preferably between 14 and 20 degrees, especially preferably between 16 and 18 degrees. Preferably, the angle of inclination of the wings in the area close to the fuselage is 17.5 degrees. In the area away from the fuselage, especially towards the free wing tip, the wings can have an angle of inclination relative to the reference axis between 5 degrees and 12 degrees, preferably between 7 degrees and 10 degrees, especially preferably between 8 degrees and 9 degrees. Preferably, the angle of inclination of the wings in the area away from the fuselage is about 8.5 degrees. Other angles of elevation are possible.

The angled shape causes an increase of the wing position in the area away from the fuselage and thus an increase of the ground clearance of the wings in this area. The landing gears are preferably arranged in an area close to the fuselage and the aircraft engines in the area of the wings that is far away from the fuselage. The angled shape of the wings allows the use of larger aircraft engines without increasing the length of the landing gear legs. This has the great advantage that when large aircraft engines are used, the landing gears do not require increased space in the lateral fuselage area in the lower deck when folded, thus providing the necessary space for the through-loading space. Furthermore, this allows the landing gears to remain at their positions in the y-direction on the wings and thus the footprint of the aircraft to remain unchanged.

As is generally known, footprints are defined by the Federal Aviation Administration in the Airport Design Document “AC 150/5300-13A”, as well as by the Airport Design Group (ADG), the International Civil Aviation Organization (ICAO), the Taxiway Design Group (TDG) and the Wake Turbulence Category (WTC).

In another preferred embodiment, the fuselage has a fuselage structure extension on both sides in the y-direction to accommodate the landing gears, which forms a free space into which the respective landing gear can be folded in at least in sections. In other words, the fuselage is widened on both sides in the area of the landing gears, preferably in the area of the landing gears, so that a free space for stowing the landing gears is formed. The fuselage structure extension is preferably designed in the area of the wing box. In cross-section, the fuselage structure extension is preferably formed by at least one straight extension of at least one upper fuselage segment in the shape of a circular segment towards a connection area of the wing. The straight extension can be designed as a tangent of the circular segment of the fuselage towards the wing. In cross-section, the fuselage can be essentially triangular in shape in the area of the fuselage structure extension, with the apexes of the triangular shape being formed by rounded circular segment-shaped fuselage segments. The fuselage segment extension on both sides has the advantage that a separate space is created to accommodate the landing gears and thus the through-loading space has no constriction of the through-loading cross-section.

Preferably, the wings have a profile cross-section that increases in size from the aircraft engines to the wing attachment area on the fuselage. This further increases the free space for stowing the landing gear.

Traditionally, aircraft wings have a profile cross-section in which the profile height is between 10 percent and 12 percent of the profile depth. The profile height towards the free wing tips is usually reduced to about 9 percent of the profile depth and in the area of the aircraft engines to between 11 and 12 percent of the profile depth. In the aircraft in accordance with the invention, the profile height in the area where the wings meet the fuselage can be between 13 and 19 percent of the profile depth, preferably between 14 and 18 percent, particularly preferably between 15 and 17 percent. In other words, the profile height in the wing attachment area is preferably 16 percent of the profile depth.

The landing gears preferably have at least one rotation axis each, around which the landing gears can be pivoted for extension and retraction. The two axes of rotation can have a distance between 930 cm and 970 cm (366 inches to 382 inches) in the y-direction and the through-loading space a clear width between 240 cm and 270 cm (94.5 inches to approx. 106 inches). Preferably, the two axes of rotation in the y-direction have a distance between 940 cm and 960 cm (370 inches to 378 inches) and the through-loading space has a clear width between 250 cm to 260 cm (approx. 98 inches to approx. 102 inches).

Particularly preferably, the two axes of rotation in the y-direction have a distance of 955 cm (376 inches) and the through-loading space has a clear width of 254 cm (100 inches). In this case, the through-loading space preferably has a clear height of 124.5 cm (49 inches). For an aircraft with a fuselage that has a maximum external height of 485 cm (191 inches) and a maximum external width of 497 cm (196 inches), a through-loading space with a clear width of 254 cm (100 inches) is provided. This has the advantage that cargo items or mobile additional tanks for fuel can accordingly be placed in the cargo space. Preferably, the aircraft is equipped with aircraft engines which are located below on the wings. With the following specifications of ICAO=D=Wing span <52 m, ADG=IV=Wing span <52 m, TDG=5=1371.6 cm (45 feet), WTC=H=>136 metric tons (300000 lbs) and AC-Parking Stand Size=5, preferably 4, the preferred dimensions for the axes of rotation and the through-loading space are as described above for the aircraft variant with the aircraft engines under the wings.

Generally known parking stand sizes for aircrafts are, for example, 38 m×47 m (“Parking Stand 3”), 48 m×58 m (“Parking Stand 4”) or 52 m×62 m (“Parking Stand 5”).

Alternatively, the two axes of rotation in the y-direction can have a distance of between 750 cm and 800 cm (approx. 295 inches to 315 inches) and the through-loading space can have a clear width of between 300 cm and 340 cm (approx. 118 inches to approx. 134 inches). Preferably, the two axes of rotation in the y-direction have a distance between 760 cm and 790 cm (approx. 299 inches to 311 inches) and the through-loading space has a clear width between 310 cm and 335 cm (122 inches to approx. 132 inches). In particular, the two axes of rotation in the y-direction have a distance of 775 cm (approx. 305 inches) and the through-loading space has a clear width of 328 cm (approx. 129 inches). The through-loading space preferably has a clear height of 173 cm (68 inches). For an aircraft with a fuselage with an outer diameter of approx. 477 cm (188 inches), in particular 472 cm (186 inches), a through-loading space with a clear width of 328 cm (approx. 129 inches) is provided. This has the advantage that the through-loading space does not have a constricted cargo space cross-section in relation to the forward and aft cargo spaces. This allows a cargo space cross-section of the through-loading space which is constant from nose to tail, i.e. does not have any constriction in the through-loading space. Preferably, the aircraft is equipped with aircraft engines, which are located at the rear of the aircraft, especially not under the wings. With the following specifications of ICAO=C=Wing span <36 m, ADG=3=Wing span <36 m, TDG=4=914.4 cm (30 feet), WTC=M=<136 metric tons (300000 lbs) and AC-Parking Stand Size=4, preferably 3, the preferred dimensions for the axes of rotation and the through-loading space for the aircraft variant with the aircraft engines at the rear of the aircraft are as described above.

For example, in the aircraft variant with the aircraft engines at the rear and with passenger seating in the upper deck and at least partially in the lower deck, the aircraft falls into a size class which includes a wing span >36 m, the outer landing gear distance in y-direction >914.4 cm (30 feet) and a weight of WTC=M, i.e. up to 136 metric tons (30000 lbs). With this aircraft variant, it is thus advantageous to transport between 200 and 270 passengers in a 79 cm (31 inch) single class configuration without “stretching” or “shrinking” the fuselage, wherein the lower deck preferably provides additional space for varying the number of passengers.

Preferably, the axes of rotation of the landing gears in the y-direction lie within the plates of the wing box. In other words, the plate ends of the plates preferably protrude beyond the axes of rotation of the landing gears in the y-direction. Preferably, the axes of rotation of the landing gears are embedded in the plates. It is particularly preferred that the landing gears are directly connected to the plates in a power-transmitting manner. For this purpose, the landing gears can be connected to the plates via joints. The advantage here is that the wing supporting structure is relieved of load and any forces occurring, for example during take-off or landing, are transmitted directly into the rigid wing box structure.

The aircraft according to the invention can have at least two aircraft engines, which are arranged at least in sections below on the wings. Alternatively or additionally, the aircraft may have at least two aircraft engines which are arranged in a region of a tail of the aircraft.

In a preferred embodiment, the aircraft comprises at least one foldable cargo space module in the lower deck, in particular several foldable cargo space modules which, when unfolded, form an interior space. The interior space may be a cargo space for transporting cargo items or a passenger compartment for transporting passengers. The foldable cargo space module is preferably arranged interchangeably in the lower deck. This allows a quick and easy reconfiguration of the lower deck e.g. from a cargo-only configuration to a passenger/cargo configuration in the lower deck. For passenger transport, the foldable cargo space module can be equipped with passenger seating before the module is placed in the lower deck. In other words, the foldable cargo space module can be inserted into the lower deck fully equipped, eliminating the need for subsequent seating. This saves time and money.

When the aircraft is provided with a cargo configuration, the foldable cargo space modules can be pre-equipped with cargo system components. When configuring the lower deck, the modules are inserted into the lower deck with the pre-assembled cargo system components. This allows a configuration of the lower deck to be carried out quickly and easily.

For example, in the variant of the aircraft with the engines at the rear, the pre-loaded cargo space module can be inserted through the aft loading opening into the lower deck and, due to the constant continuous cargo space cross-section in the longitudinal direction of the aircraft, pushed from the rear to the front. This allows the configuration or reconfiguration of the lower deck with very little time expenditure.

Thus, the following possible configurations of the aircraft for passenger and/or cargo transport result:
Upper deck with passenger seating for pure passenger transport on the upper deck and lower deck as cargo space for pure cargo transport;
Upper deck with passenger seating for passenger transport only and lower deck with sectional passenger seating for passenger transport and as sectional cargo space for cargo transport. Here the lower deck is designed for passenger and cargo transport; and/or
Upper deck and lower deck as a cargo space for pure cargo transport. In this variant, no passenger transport is provided, except for the aircraft crew.

In the aforementioned aircraft configurations, it is possible to provide mobile auxiliary fuel tanks in the wing box area instead of cargo containers or packages in order to extend the range of the aircraft if necessary.

The foldable cargo space module may additionally or alternatively have at least one pre-assembled galley ring and/or at least one pre-assembled sanitary area, in particular a toilet area, of the lower deck.

With regard to the foldable cargo space module, reference is also made to application DE 10 2019 132 292.8, the contents of which are hereby incorporated in this application, in particular with regard to feasibility.

A subsidiary aspect of the invention relates to an aircraft for cargo and passenger transport with a fuselage extending in the longitudinal direction and having an upper deck, in particular the main deck, and a lower deck separated from each other by a floor. The fuselage has a barrel section with a cross-sectional profile to accommodate cargo and/or passengers. The cross-sectional profile is formed by a single, in particular continuous, circle, so that the upper deck and the lower deck can accommodate cargo items with different size dimensions, in particular cargo containers with different height and width dimensions. The aircraft in accordance with the secondary aspect can be combined with the features of the embodiments of the aircraft in accordance with the invention as described above.

According to alternative independent claim 15, the invention relates to a cargo container for transporting cargo items in an aircraft, which has a trapezoidal base body with a floor region and a ceiling region arranged opposite one another, wherein the floor region comprises at least one fastening element which can be connected to a fastening device of the aircraft, and wherein the floor region comprises at least one first longitudinal side of at least 240 cm (94.5 inches), in particular 244 cm (96 inches), and the ceiling region comprises at least one second longitudinal side of at least 315 cm (124 inches), in particular 317 cm (125 inches), wherein the cargo container has an overall height of at least 99 cm to a maximum of 130 cm (39.5 inches to 51 inches).

In a preferred embodiment, the cargo container has an overall height of at least 102 cm to a maximum of 127 cm (40 inches to 50 inches). Preferably, the cargo container has a total height of 114.5 cm (45 inches). Alternatively, the cargo container can have a total height of approx. 127 cm (approx. 50 inches). Preferably the cargo container has a depth of 153.5 cm (60.4 inches).

According to the alternative independent claim 16, the invention relates to a method for loading an aircraft according to the invention, wherein the lower deck of the aircraft has a forward cargo space, an aft cargo space and, in the region of a wing box, a through-loading space which connects the forward cargo space and the aft cargo space. The lower deck has a forward loading opening which can be closed by a loading door. During a loading process at least one cargo item, in particular a cargo container, is introduced into the forward cargo space through the forward loading opening and then loaded through the through-loading space into the aft cargo space.

The invention can also be seen in a method for reconfiguring an aircraft, in particular an aircraft as described above. In this reconfiguration procedure, foldable cargo space modules or foldable modules are used to quickly reconfigure the aircraft between different configurations, e.g. the configurations already described. Preferably, the foldable modules already described are used for this purpose, which are also explained in detail in the application DE 10 2019 132 292.8.

In one embodiment of the cargo space modules, these may be provided with a floor and at least two side walls preferably hinged to the floor. These can be brought into the aircraft, preferably into the (lower) cargo space, and mounted via a loading door. Preferably, they are mounted on the lower deck, for example in the front area of the aircraft. Here it proves to be advantageous that the aircraft according to the invention can have the through-loading space already described. In one embodiment, the cargo space module is assembled to provide passenger seats in the lower deck, wherein the module preferably has pre-assembled seats and/or holding devices for the assembly of seats during insertion.

In one embodiment, at least one cargo space module for pallets and/or containers can be disassembled before the cargo space modules for passenger seats are inserted, and then removed from the interior of the aircraft through the same loading door. This at least one cargo space module for pallets and/or containers can also be a foldable module. Parts of a cargo loading system, such as roller conveyors, latches, side guides and/or stops may be pre-assembled.

In one embodiment, first a plurality of cargo space modules for passenger seats and then cargo space modules for pallets and/or containers are placed and assembled in the aircraft, so that the cargo space can be used partly to accommodate passengers and partly to accommodate cargo, especially pallets and/or containers.

According to the alternative independent claim 18, the invention relates to an aircraft for cargo and/or passenger transport having a fuselage extending in longitudinal direction and having an upper deck, in particular main deck, and a lower deck. The upper deck and the lower deck are separated by a floor. The fuselage has a barrel section with a cross-sectional profile to accommodate cargo items and/or passengers. The aircraft is designed as a low-deck or mid-deck configuration. The lower deck has a forward cargo space, an aft cargo space and, in the area of the wing box, a through-loading space which connects the forward cargo space and the aft cargo space, wherein the through-loading space in the area of the wing box or the landing gear is designed in such a way that, when the lower deck is loaded, cargo containers can be loaded through from the nose and/or tail of the aircraft. The cross-sectional profile can optionally be formed by several circular arc sections with radii having different centers or the cross-sectional profile can be formed by a single circle. However, according to the invention, the cross-sectional profile can also be designed in any other way.

Regarding the advantages of the cargo container as well as the method for loading an aircraft, reference is hereby made to the advantages explained in connection with the aircraft, which are applied accordingly. In addition, the cargo container and the method may alternatively or additionally have individual or a combination of several features previously mentioned in relation to the aircraft.

### BRIEF DESCRIPTION OF THE DRAWINGS

The invention is explained in more detail below with reference to the attached drawings. The embodiments shown are examples of how the aircraft and cargo container according to the invention can be designed. They show as follows:

FIG. 1 shows a cross-section of a barrel section of the fuselage of an aircraft according to a preferred exemplary embodiment according to the invention in a cargo configuration with a first loading variant;

FIG. 2 shows a cross-section of the barrel section of the fuselage as shown in FIG. 1 in the cargo configuration with a second loading variant;

FIG. 3 shows a cross-section of the barrel section of the fuselage as shown in FIG. 1 in a cargo configuration with a third loading variant;

FIG. 4 shows a cross-section of the barrel section of the fuselage as shown in FIG. 1 in a passenger configuration with a first transport variant;

FIG. 5 shows a cross-section of the barrel section of the fuselage as shown in FIG. 1 in a passenger configuration with a second transport variant;

FIG. 6 shows a cross-section through the aircraft according to FIG. 1 in the area of the wing box;

FIG. 7 shows a cross-section through the aircraft according to FIG. 1 in the area of the landing gear;

FIG. 8 shows a perspective bottom view of the aircraft according to FIG. 1;

FIG. 9 shows a perspective top view of the aircraft according to FIG. 1;

FIG. 10 shows a longitudinal section through the aircraft according to FIG. 1, with the lower deck loaded with cargo items;

FIG. 11 shows a longitudinal section through the aircraft according to FIG. 1, wherein several mobile additional tanks are arranged in the lower deck in the area of the wing box;

FIG. 12 shows a perspective view of a cargo container according to an exemplary embodiment according to the invention;

FIG. 13 shows a front view of the cargo container according to FIG. 12;

FIG. 14 shows a cross-section of a barrel section of the fuselage of an aircraft according to another exemplary embodiment according to the invention;

FIG. 15 shows a cross-section of a barrel section of the fuselage of an aircraft according to another exemplary embodiment according to the invention;

FIG. 16 shows several different loading/equipment configurations of the upper deck of the aircraft as shown in FIG. 1, FIG. 14 and FIG. 15;

FIG. 17 shows several different loading configurations of the lower deck of the aircraft according to FIG. 1 and FIG. 14;

FIG. 18 shows a section of a side view of an aircraft according to another exemplary embodiment according to the invention;

FIG. 19a-d show cross-sections through the aircraft as shown in FIG. 18 at different positions along the longitudinal direction of the aircraft;

FIG. 20 shows a perspective view of a longitudinal section through the aircraft according to FIG. 18 in the area of the wing box;

FIG. 21 shows a front view of the aircraft according to FIG. 18;

FIG. 22 shows a cross-section through the aircraft according to FIG. 18 in the area of the landing gears, wherein these are shown in the folded-out state;

FIG. 23 shows a cross-section through the aircraft according to FIG. 18 in the area of the landing gears, wherein these are shown in the folded-in state;

FIG. 24 shows a perspective view of an aircraft according to another exemplary embodiment of an invention;

FIG. 25 shows a cross-section through the aircraft according to FIG. 24 in the area of the landing gears, wherein these are shown in the folded-in and folded-out state;

FIG. 26 shows a schematic top view of a barrel section of the aircraft according to FIG. 24 in the area of the wing box and landing gear;

FIG. 27 shows a side view of the aircraft according to FIG. 24 in a first deck configuration;

FIG. 28 shows a side view of the aircraft according to FIG. 24 in a second deck configuration;

FIG. 29 shows a side view of the aircraft according to FIG. 24 in a third deck configuration;

FIG. 30 shows a side view of the aircraft according to FIG. 24 in the first deck configuration as shown in FIG. 27, wherein at least the outer fuselage skin and the configuration of the upper deck are hidden;

FIG. 31 shows a side view of the aircraft according to FIG. 24 in the second deck configuration according to FIG. 28 and in the third deck configuration according to FIG. 29, wherein at least the outer fuselage skin and the upper deck configuration are hidden; and

FIG. 32 shows a cross-section of a barrel section of the fuselage of an aircraft according to another exemplary embodiment according to the invention.

### DETAILED DESCRIPTION

In the following description, the same reference numerals are used for identical and similarly acting parts.

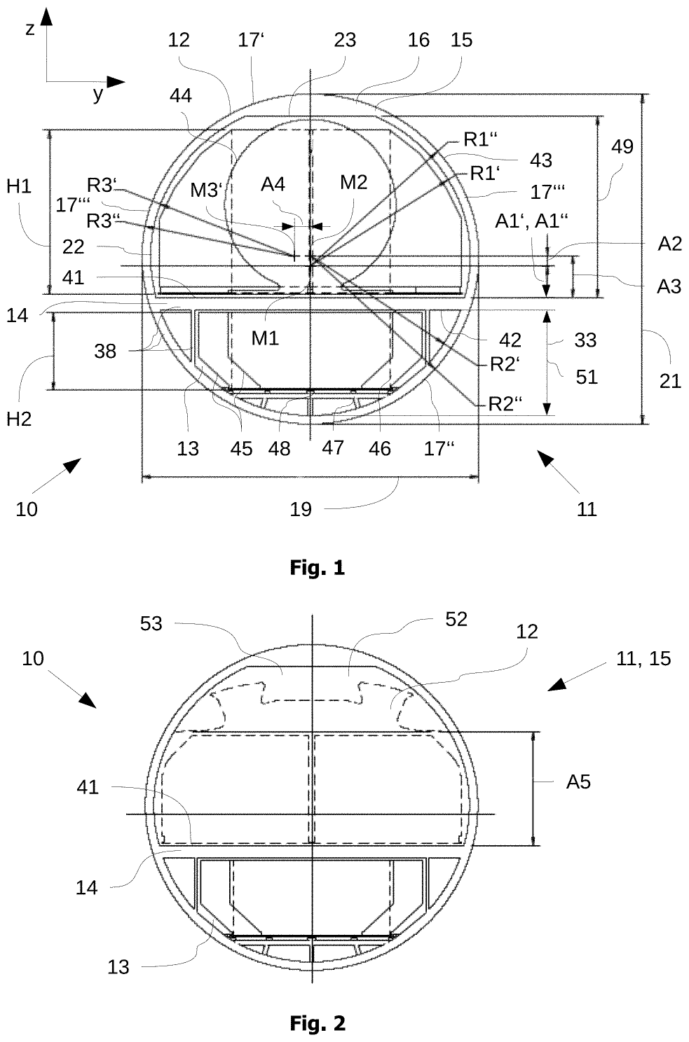

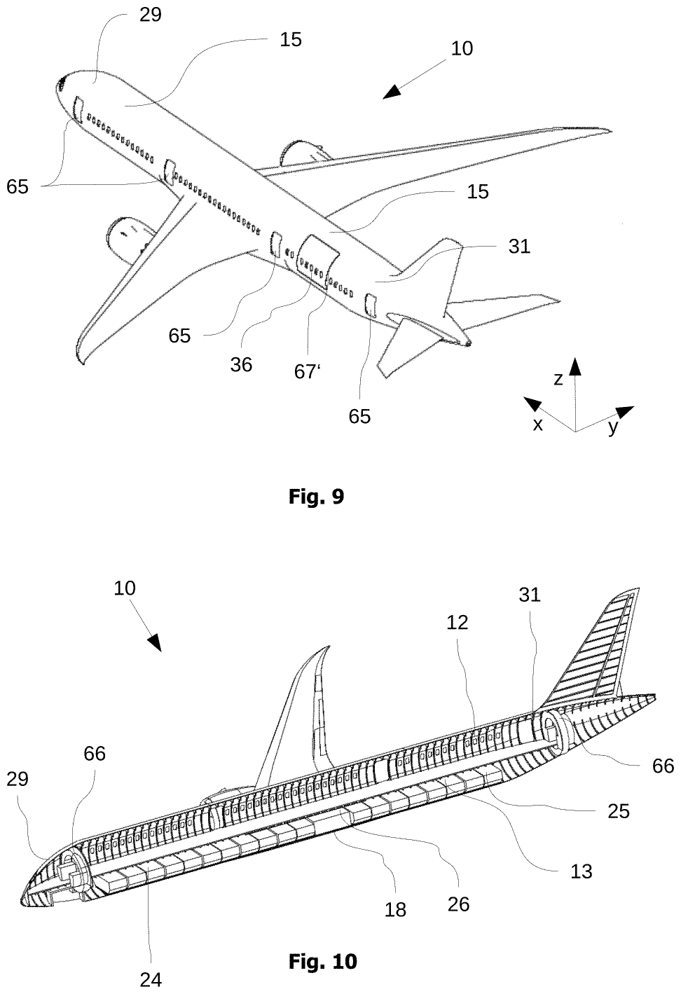

Usually, a Cartesian coordinate system is used to provide individual directional information within an aircraft. The x-axis extends from the tail to the nose of the aircraft, the y-axis is transverse to the x-axis and lies essentially in the plane defined by the wings. The z-axis is perpendicular to the x- and y-axis (see FIG. 1 and FIG. 9). The longitudinal direction corresponds to the x-direction of the aircraft and is parallel to the x-axis. The y-direction of the aircraft is parallel to the y-axis and the z-direction is parallel to the z-axis.

FIGS. 1 to 5 show a cross-section of an aircraft 10 according to an exemplary embodiment according to the invention. The aircraft 10 is designed as a low-wing aircraft. Specifically, FIGS. 1 to 5 show a cross-section through a barrel section 15 of a fuselage 11 of aircraft 10, wherein the barrel section 15 extends longitudinally and comprises a part of the upper deck 12 and a part of the lower deck 13. The upper deck 12 may also be referred to as the main deck and the lower deck 13 as the cargo deck. The two decks 12, 13 are separated by a floor 14.

The floor 14 has an upper edge 41 and a lower edge 42, with the upper edge 41 facing the upper deck 12 and the lower edge 42 facing the lower deck 13. The following height measurements concerning the upper deck 12 are measured from the upper edge 41 of the floor 14 in z-direction upwards. Furthermore, the following height measurements concerning the lower deck 13 are measured from the lower edge 42 of the floor 14 in z-direction downwards. The upper edge 41 and the lower edge 42 each form the maximum extension of the floor 14 in z-direction.

Floor 14 is spaced from the y-axis of aircraft 10 in negative z-direction. Preferably, the upper edge 41 of floor 14 has a distance A1′ of at least 40 cm to a maximum of 55 cm (16 inches to 22 inches). As shown in FIG. 1, the distance A1′ of the upper edge 41 of floor 14 from the y-axis of the aircraft 10 is approximately 47 cm (approx. 18.5 inches).

The barrel section 15 has a cross-sectional profile 16, which is formed by several circular arc sections 17, which have radii R1, R2, R3 with centers M1, M2, M3′, M3″ that differ from each other. The circular arc sections 17 each comprise an inner radius R1′, R2′, R3′ and an outer radius R1″, R2″, R3″, which will be discussed in more detail later. The cross-sectional profile 16 is designed in such a way that cargo items 18 with different size dimensions, in particular cargo containers 18 with different height and width dimensions, can be accommodated in the upper deck 12 and the lower deck 13.

According to FIGS. 1 to 5, the cross-sectional profile 16 is designed oval in shape. The barrel section 15 has an outer maximum width 19 of 497 cm (196 inches) in the y-direction and an outer maximum height 21 of 485 cm (191 inches) in the z-direction. In addition, barrel section 15 has a first clear width 22, especially an inner maximum width, of 472.5 cm (186 inches) in the y-direction and a second clear width 23, especially an inner maximum height, of 460 cm (181 inches) in the z-direction.

In other words, the barrel section 15 in the z-direction has an outer maximum height of 485 cm (191 inches) and an inner maximum height, especially second clear width 23, of 460 cm (181 inches). In addition, barrel section 15 in the y-direction has an outer maximum width of 497 cm (196 inches) and an inner maximum width, especially first clear width 22, of 472.5 cm (186 inches).

Preferably, the fuselage 11 or the barrel section 15 has a wall thickness of the fuselage outer skin 43 of approx. 13 cm (5 inches). The outer maximum width 19 and the outer maximum height 21 may have a dimensional tolerance of +/−5%, in particular a dimensional tolerance of less than 2%, in particular a dimensional tolerance of +/−0.5%. The two clear widths 22, 23 can have a dimensional tolerance of +/−5%, in particular a dimensional tolerance of less than +2%, in particular a dimensional tolerance of +/−1% or +/−0.7%. In other words, the outer maximum width 19 and the outer maximum height 21 can vary in the range of +/−5%, preferably in the range of +/−0.5%. The two clear widths 22, 23 can vary in the range of +/−5%, preferably in the range of +/−1% or +/−0.7%. This dimensional tolerance also applies to the wall thickness of the fuselage outer skin 43.

The upper deck 12 may have a clear width 49, in particular clear height, in the barrel section 15 starting from the upper edge 41 of floor 14, in the z-direction of aircraft 10 of at least 254 cm to a maximum of 287 cm (100 inches to 113 inches), in particular of at least 264 cm to 273 cm (104 inches to 107 inches). Specifically, the upper deck 12 in the barrel section 15 in the z-direction has a clear width 49 of 268.6 cm (105.75 inches). Alternatively, it is conceivable that the upper deck 12 in barrel section 15 has a clear width 49 of 284.75 cm (112.5 inches) in the z-direction.

The cross-sectional profile 16 of barrel section 15 may be designed in such a way that the upper deck 12 has a clear width 49, in particular height, in the z-direction of at least 280 cm to a maximum of 300 cm (approx. 110 inches to approx. 118 inches), in particular of at least 285 cm to 290 cm (approx. 112 inches to approx. 114 inches). Preferably, the upper deck 12 in the barrel section 15 in z-direction may have a clear width 49 of 288 cm (approx. 113.5 inches).

The lower deck 13 may have a clear width 51, in particular clear height, in the barrel section 15 in the z-direction of at least 140 cm (55 inches), in particular at least 127 cm (50 inches). Specifically, lower deck 13 in barrel section 15 has a clear width 51 of at least 124.5 cm (49 inches) in the z-direction. The clear width 51 of the lower deck 13 is essentially measured from a floor structure 47, which has a roller conveyor system 48 for loading the lower deck 13 and securing the cargo items, to the lower edge 42 of the floor 14. The floor structure 47 will be discussed in more detail later. The clear widths 49, 51 of the two decks 12, 13 can be essentially constant throughout the barrel section 15.

The lower deck 13 can have a minimum usable width in the barrel section 15 in y-direction of approx. 317.5 cm (approx. 125 inches). Preferably, the lower deck 13 in barrel section 15 has a width in y-direction of approx. 328 cm (approx. 129 inches).

As described above, the cross-sectional profile 16 has several circular arc sections 17, wherein the cross-sectional profile 16 is formed by a total of four circular arc sections 17′, 17″, 17′″. A first circular arc section 17′ partially spans the upper deck 12, a second circular arc section 17″ delimits the lower deck 13 and two third circular arc sections 17′″ are arranged between the first and the second circular arc section 17′, 17″. The third circular arc sections 17′″ are arranged opposite each other with respect to the z-axis of the aircraft 10. The two third circular arc sections 17′″ are adjacent in each case to the first circular arc section 17′ and the second circular arc section 17″. In other words, the third circular arc section 17′″ connects the first circular arc section 17′ and the second circular arc section 17″ to each other. The four circular arc sections 17 are arranged in such a way that the cross-sectional profile 16 is formed symmetrically. Specifically, the cross-sectional profile 16 is mirror-symmetrical in relation to the z-axis.

As can be seen in FIG. 1, the first circular arc section 17′ has an inner radius R1′ and an outer radius R1″. The inner radius R1′ is 239 cm (94 inches) and the outer radius R1″ is 252 cm (99 inches). The center M1 of the two radii R1 is located on the z-axis of the aircraft 10 and is spaced from the floor 14 in a positive z-direction, especially upward. The center M1 of the two radii R1 is formed by the intersection of the z- and y-axis of aircraft 10. In other words, the center M1 is exactly at the intersection of the z- and y-axis of the aircraft 10. Preferably, the center M1 of the two radii R1 has a distance A1″ of at least 40 cm to a maximum of 55 cm (16 inches to 22 inches) from the upper edge 41 of the floor 14. According to FIG. 1, the distance A1″ of the center M1 of the two radii R1 from the upper edge 41 of the floor 14 is approximately 47 cm (approx. 18.5 inches).

Furthermore FIG. 1 shows that the second circular arc section 17″ also has an inner radius R2′ and an outer radius R2″. The inner radius R2′ is 236 cm (93 inches) and the outer radius R2″ is 249 cm (98 inches). The center M2 of the two radii R2 is on the z-axis of the aircraft 10. The center M2 of the second circular arc section 17″ is spaced from the center M1 of the first circular arc section 17′ in the positive z-direction. In other words, the center M2 of the second circular arc section 17″ is offset upward in the z-direction away from the center M1 of the first circular arc section 17′. The center M2 of the second circular arc section 17″ is thus spaced from the y-axis in positive z-direction, in particular upwards. Preferably, the center M2 of the second circular arc section 17″ is at a distance A2 of at least 5 cm to a maximum of 25 cm (2 inches to 10 inches) from the center M1 of the first circular arc section 17′. According to FIG. 1, the distance A2 of the center M2 of the second circular arc section 17″ from the center M1 of the first circular arc section 17′ is approximately 15 cm (6 inches).

Furthermore, the center M2 of the second circular arc section 17″ is spaced from the upper edge 41 of the floor 14 in positive z-direction. Preferably, the center M2 of the second circular arc section 17″ from the upper edge 41 of the base 14 is at a distance A3 of at least 50 cm to a maximum of 70 cm (20 inches to 28 inches). According to FIG. 1, the distance A3 of the center M2 of the second circular arc section 17″ from the upper edge 41 of the base 14 is approx. 62 cm (24.5 inches).

The centers M3′, M3″ of the third circular arc sections 17′″ can be at the same height in z-direction as the center M2 of the second circular arc section 17″. The centers M3′, M3″ of the third circular arc sections 17′″ have a distance of approx. 58.5 cm (23 inches) in z-direction from the upper edge 41 of the floor 14. The centers M3′, M3″ of the third circular arc sections 17′″ are offset from the z-axis in the opposite y-direction. The centers M3′, M3″ are arranged opposite each other on the z-axis, with the centers M3′, M3″ having the same distance to the z-axis. It is also conceivable that the centers M3′, M3″ are at different distances from the z-axis. For the sake of clarity, only the two radii R3 and the center M3′ of one of the two third circular arc sections 17′″ are shown in FIG. 1. However, the following description applies to both third circular arc sections 17′″ and their radii R3 and centers M3′, M3″. The center M3 has a distance A4 to the z-axis in the y-direction, which is preferably at least 15 cm to a maximum of 35 cm (6 inches to 14 inches). According to FIG. 1, the distance A4 of the center M3′ to the z-axis is approx. 22.5 cm (approx. 9 inches).

Furthermore, FIG. 1 shows that the third arc section 17′″ also has an inner radius R3′ and an outer radius R3″. The two third circular arc sections 17′″ are identical or identical in design. The inner radius R3′ is 213 cm (84 inches) and the outer radius R3″ is 226 cm (89 inches).

The inner radius R1′ of the first circular arc section 17′ is smaller than the inner radius R2′ of the second circular arc section 17″. Furthermore, the outer radius R1″ of the first circular arc section 17′ is smaller than the outer radius R2″ of the second circular arc section 17″. The inner radii R3′ of the two third circular arc sections 17′″ are smaller than the inner radii R1′, R2′ of the first and second circular arc sections 17′, 17″. Furthermore, the outer radii R3″ of the two third circular arc sections 17′″ are smaller than the outer radii R1″, R2″ of the first and second circular arc sections 17′, 17″.

In general, the dimensions of the radii R1, R2, R3 are not limited to the aforementioned dimensions. Other dimensions of radii R1, R2, R3 not mentioned above are also possible.

According to FIGS. 1 to 5, the third circular arc sections 17′″ are designed in such a way that they have a height of 80 cm to 120 cm (32 inches to 47 inches) in the z-direction, in particular a height of approx. 104 cm to approx. 109 cm (40 inches to 443 inches). The third circular arc sections 17′″ have a concrete height of approx. 104 cm (41 inches). The height is measured starting from a height position of the centers M3′, M3″ of the third circular arc sections 17′″ in z-direction. In the third circular arc sections 17′″ at least one row of windows of aircraft 10 can be provided. Starting from the upper edge 41 of the floor 14, the third circular arc sections 17′″ in z-direction can have a height of approx. 140 cm to approx. 170 cm (approx. 55 inches to approx. 67 inches). Specifically, the third circular arc sections 17′″ in the z-direction, starting from the upper edge 41 of the floor 14, have a height of approx. 162 cm (approx. 64 inches). This enables the arrangement of the window row in the third circular arc sections 17′″, since conventional windows have a height of approx. 45 cm to approx. 48 cm (18 inches to 19 inches).

As shown in FIG. 1, aircraft 10 is configured for cargo transport, wherein a first loading variant of the upper and lower decks 12, 13 is shown. With the first loading variant, an aircraft engine 44, especially of the own aircraft type, can be introduced into the upper deck 12. Furthermore, two first cargo containers 18′, especially AAJ containers, having the basic dimensions 223.5 cm by 317.5 cm (88 inches×125 inches) and a height H1 of 243.8 cm (96 inches), can be arranged next to each other in the y-direction on upper deck 12. Alternatively or additionally, at least one second cargo container 18″, in particular an AMA container, having the basic dimensions 243.8 cm by 317.5 cm (96 inches×125 inches) and a height H1 of 243.8 cm (96 inches), can be introduced into the upper deck 12.

In addition, trapezoidal cargo containers 45 having the basic dimensions of 153.4 cm×156.2 cm (60.4 inches×61.5 inches) and/or 153.4 cm×243.8 cm (60.4 inches×96 inches) and each with a height H2 of approx. 114 cm to approx. 127 cm (approx. 45 inches to approx. 50 inches) can be introduced into the lower deck 13 for the first loading variant. Furthermore, at least one pallet 46, in particular PMC, having the dimensions 243.8 cm×317.5 cm (96 inches×125 inches) and a height H2 of approx. 114 cm to approx. 127 cm (approx. 45 inches to approx. 50 inches), can be introduced lengthwise into the lower deck 13.

The lower deck 13 has a floor structure 47 with a roller conveyor system 48 to accommodate and secure the cargo items 18 or cargo containers 18′, 18″, 45 and/or pallets 46.

According to FIG. 2, aircraft 10 is configured for cargo transport, wherein a second loading variant of upper deck 12 is shown. The loading of the lower deck 13 corresponds to that of the first loading variant as shown in FIG. 1, whereas the second loading variant is equipped with a receiving device 52 for cargo, especially luggage, in the ceiling area 53 of the upper deck 12. The shortest distance A5 between the receiving device 52 and the upper edge 41 of deck 14 can be between 160 cm and 180 cm (63 inches and 71 inches).

Specifically, the shortest distance A5 between the receiving device 52 and the upper edge 41 of the base 14 is approximately 175 cm (approx. 69 inches). Therefore, cargo containers and/or pallets with a height of 163 cm (64 inches) can be arranged in the upper deck 12 below the receiving device 52. Specifically, two third cargo containers 18′″, in particular LAJ containers, having the basic dimensions 223.5 cm by 317.5 cm (88 inches×125 inches) and a height of 163 cm (64 inches), and/or two pallets, in particular PAG pallets, having the basic dimensions 223.5 cm by 317.5 cm (88 inches×125 inches) and a height of 163 cm (64 inches), and/or two pallets, especially HCU-6E pallets, having the basic dimensions 223.5 cm by 274.3 cm (88 inches×108 inches) and a height of 163 cm (64 inches), can be arranged next to each other in the y-direction.

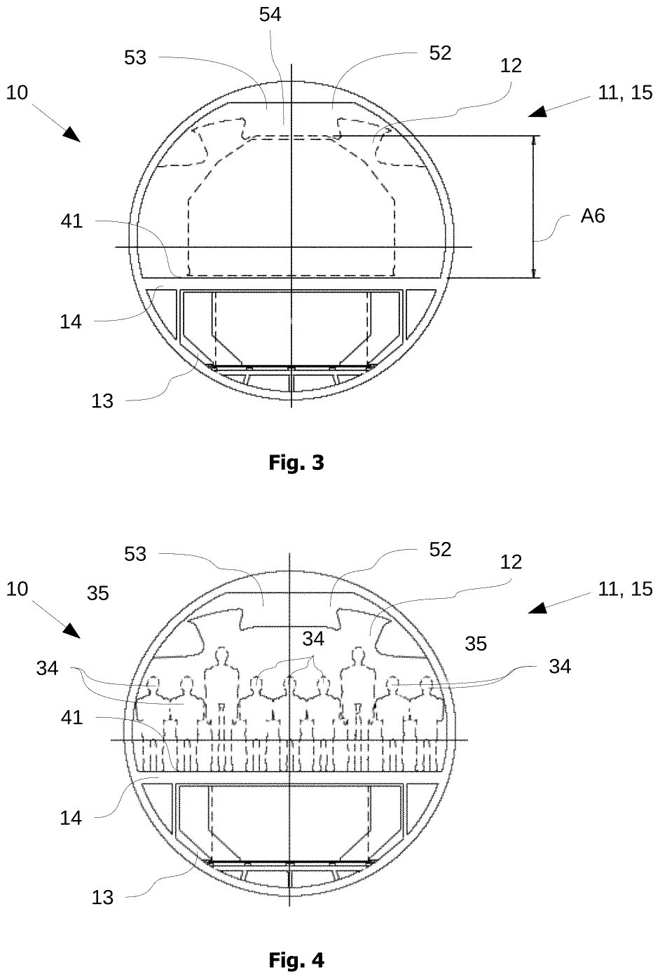

According to FIG. 3, aircraft 10 is shown with a third loading variant of the upper deck 12. The loading of the lower deck 13 corresponds again to the first loading variant as shown in FIG. 1. In the upper deck 12, the receiving device 52 for cargo items, as described in FIG. 2, is provided in the ceiling area 53, wherein the receiving device 52 has a central area 54, especially in the area of the z-axis of the aircraft 10. Between the central area 54 and the upper edge 41 of the floor 14, there is a distance A6, which can be between 203 cm and 229 cm (80 inches and 90 inches). According to FIG. 3, the distance A6 is approximately 217 cm (approx. 86 inches).

According to FIG. 4, aircraft 10 is configured for passenger transport. A first transport variant of upper deck 12 is shown. The loading of the lower deck 13 again corresponds to the first loading variant as shown in FIG. 1. In the upper deck 12, the receiving device 52 for cargo items is provided in the ceiling area 53 as described in FIG. 2. The upper deck 12 has seven rows of seats 34. The rows of seats 34 extend in the x-direction of the aircraft 10. The rows of seats 34 are provided as 2-3-2 configuration. Specifically, two rows of seats 34 are arranged laterally outside in opposite y-direction. These form the window rows. The three remaining seat rows 34 are arranged between the lateral seat rows 34. These form the center seat rows. An aisle 35 is provided between each of the side rows 34 and the center rows 34, extending in the x-direction of the aircraft 10. The aisles 35 can each have a width in the y-direction between the adjacent rows of seats of 38 cm to 65 cm (15 inches to 25.6 inches). Specifically, the aisles 35 have a width in the y-direction between the adjacent rows of seats 34 of approximately 52 cm (20.5 inches).

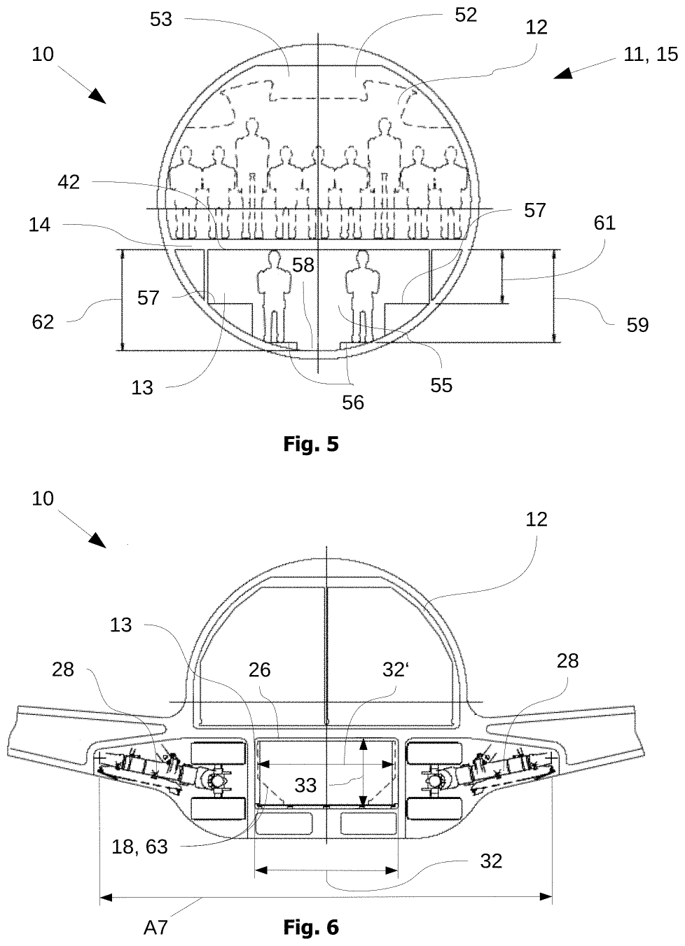

According to FIG. 5, aircraft 10 is configured for passenger transport, wherein a second transport variant of lower deck 13 is shown. The seating on the upper deck 12 corresponds to the first transport variant as shown in FIG. 4. According to FIG. 5, a common area 55 for the aircraft personnel is provided on lower deck 13. The common area 55 has two first areas 56 for sitting and two second areas 57 for sleeping or reclining for the flight crew. Between the two areas 56 for sitting a walking area 58 is provided. The first area 56, the second area 57 and the walking area 58 are essentially the same width in y-direction. The width of each of the areas 56, 57, 58 in y-direction can vary from a minimum of 56 cm to a maximum of 81 cm (22 inches to 32 inches). Specifically, the areas 56, 57, 58 in y-direction each have a width of approx. 68.4 cm (approx. 26.9 inches). With respect to the first areas 56, the second areas 57 are raised. The lower deck 13 preferably has a first clear width 59 in z-direction between the first areas 56 and the lower edge 42 of the floor 14 of at least 125 cm to a maximum of 150 cm (49 inches to 59 inches), in particular of at least 140 cm to a maximum of 145 cm (55 inches to 57 inches). According to FIG. 5, the first clear width 59 is approx. 143 cm (approx. 56 inches).

In addition, the lower deck 13 preferably has a second clear width 61 in the z-direction of at least 75 cm to a maximum of 90 cm (29.5 inches to 35.5 inches), in particular from at least 81 cm to a maximum of 85 cm (32 inches to 34 inches), preferably between the second area 57 and the lower edge 42 of the floor 14. According to FIG. 5, the second clear width 61 is approximately 83 cm (33 inches).

The lower deck 13 preferably has a third clear width 62, preferably in the z-direction between walking area 58 and the lower edge 42 of floor 14, of at least 145 cm to a maximum of 165 cm (57 inches to 65 inches), in particular of at least 150 cm to 160 cm (59 inches to 63 inches). According to FIG. 5, the third clear width 62 is approximately 156 cm (approx. 61.5 inches).

The aircraft 10 according to FIGS. 6 to 11 has a forward cargo space 24 in the lower deck 13, an aft cargo space 25 and a through-loading space 26 in the area of a wing box 27 and a landing gear 28. The through-loading space 26 connects the forward cargo space 24 and the aft cargo space 25 to each other. In other words, the lower deck 13 is designed to be continuous in the x-direction so that in the area of a wing box 27 and/or in the area of a landing gear 28 at least one mobile additional tank 63 and/or at least one cargo container 18 can be accommodated. The lower deck 13 is loaded with cargo containers 18 and/or mobile additional tanks 63 as shown in FIGS. 6, 7, 10 and 11.

FIG. 6 shows a cross-section through the aircraft 10 in the area of landing gear 28, with landing gear 28 in a retracted state. In the area of the landing gear 28, the through-loading space 26 can have a minimum width 32 in the y-direction of the aircraft 10 of at least 240 cm to a maximum of 270 cm (94.5 inches to 106.5 inches), in particular of at least 250 cm to a maximum of 260 cm (98.5 inches to 102.5 inches). Specifically, the through-loading space 26 has a minimum usable width of 32′ in the y-direction of 244 cm (96 inches). In the y-direction, landing gear 28 has a distance A7 between the two axes of rotation of approximately 956.6 cm (approx. 376 inches).

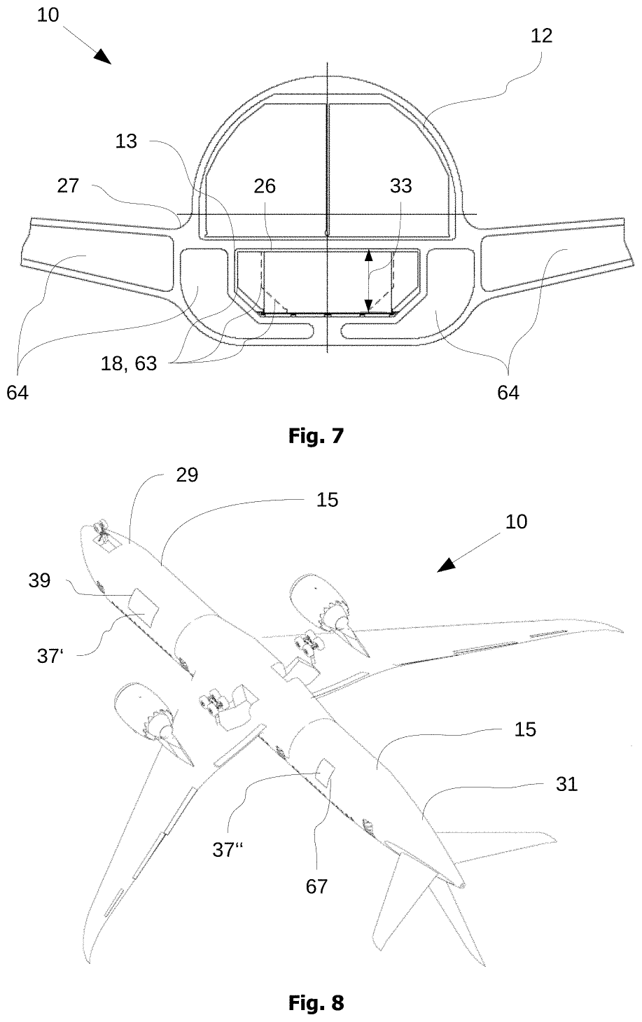

According to FIG. 7, a cross-section through the aircraft 10 is shown in the area of the wing box 27. There are no permanently installed central tanks for fuel in wing box 27. The permanently embedded fuel tanks 64 of the aircraft 10 are located laterally next to the through-loading space 26. In the area of the wing box 27, the through-loading space 26 has a width which corresponds to the width of the forward and/or aft cargo space 24, 25. The width of the through-loading space 26 in the area of the wing box 27 is larger than the width of the through-loading space 26 in the area of the landing gear 28. The through-loading space 26 can have a minimum usable width in y-direction of approximately 317.5 cm (approx. 125 inches) in the area of the wing box 27. Preferably, the through-loading space 26 in the area of the wing box 27 has a width in y-direction of approximately 328 cm (approx. 129 inches).

Cargo containers 18 and/or mobile additional tanks 63 with a width of approximately 244 cm (96 inches) can be arranged in the through-loading space 26 as shown in FIGS. 6 and 7 or moved through the through-loading space 26. Preferably, only cuboidal cargo containers with a width of approximately 244 cm (96 inches) and a height of approximately 114.5 cm (45 inches) can be placed and/or moved through the through-loading space 26 in the area of the landing gear 28.

The through-loading space 26 has a through-loading height 33 of at least 140 cm (55 inches), in particular of at least 130 cm (51 inches). Preferably, the through-loading space 26 has a through-loading height 33 of at least 124.5 cm (49 inches). The through-loading height 26 corresponds to the clear width 51, in particular height, in z-direction of the lower deck 13. The through-loading height 33 can be essentially constant.

As shown in FIGS. 8 and 9, aircraft 10 has one loading door 36 for loading and unloading the upper deck 12 and two loading doors 37′, 37″ for loading and unloading the lower deck 13. As shown in FIG. 8, one of the two loading doors 37″ is located forward and one of the two loading doors 37″ is located aft. The forward loading door 37″ closes a loading opening 39, especially the front one, through which the forward loading space 24 is accessible for loading and unloading. The aft loading door 37′ closes an aft loading opening 67, especially at the rear, through which the aft loading space 25 is accessible for loading and unloading. The forward loading opening 39 is larger than the aft loading opening 67, while the forward loading opening 39 has a passage size with a minimum width of approximately 332.5 cm (131 inches) and a minimum height of 124.5 cm (49 inches) or 137 cm (54 inches). The aft loading opening 67 has a passage size with a minimum width of 168 cm (66 inches) and a minimum height of 124.5 cm (49 inches) or 137 cm (54 inches).

The loading door 36 as shown in FIG. 9 is located at the rear and closes an aft loading opening 67′ for loading and unloading the upper deck 12. The loading opening of the upper deck 12 can have a passage size with a minimum clear width of 370 cm to 380 cm (approx. 145.5 inches to approx. 149.5 inches). More specifically, the loading opening of the upper deck 12 can have a passage size with a minimum clear width of 373 cm to 376 cm (approx. 147 inches to approx. 148 inches). The loading doors 36, 37′, 37″ are each located in a barrel section 15.

When loading the lower deck 13, the cargo items 18 and/or cargo containers 45 can be introduced through the forward loading opening 39 into the forward cargo space 24 and then loaded through the through-loading space 26 into the aft cargo space 25. It is also possible that when loading the lower deck 13, the cargo items 18 and/or cargo containers 45 are loaded through the aft loading opening 67 into the aft cargo space 25 and then through the through-loading space 26 into the forward cargo space 24.

As can be seen in FIG. 9, the aircraft 10 also has four doors 65 for passengers on each of the long sides. The doors are located outside the wings in the longitudinal direction of the aircraft 10. This enables a safe evacuation in case of an emergency.

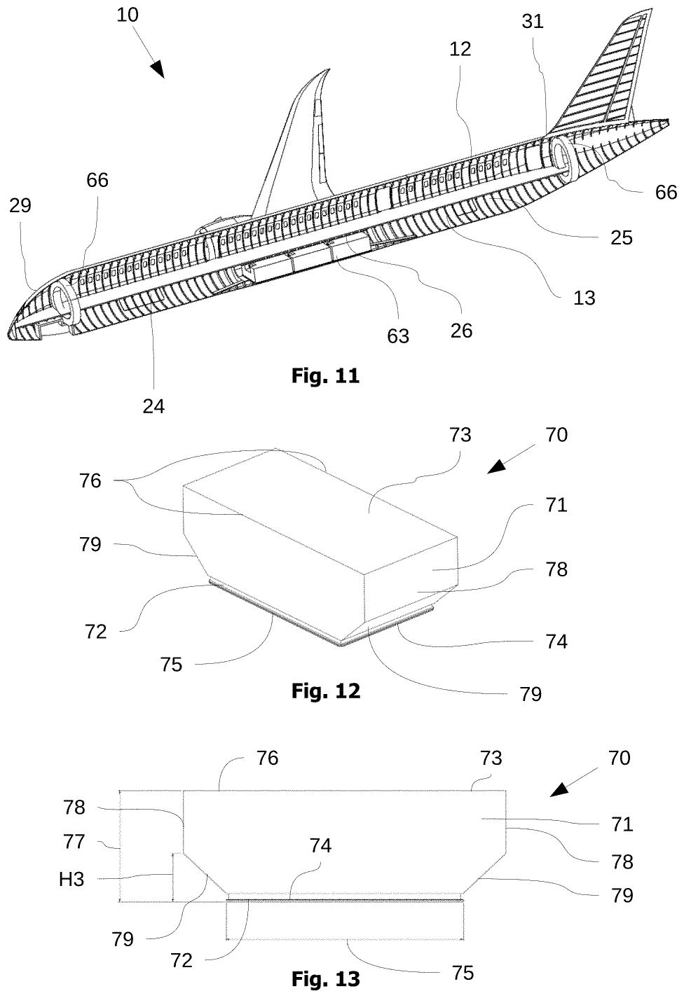

FIGS. 10 and 11 show two different loading variants for the lower deck 13, wherein in FIG. 10 only cargo items 18 or cargo containers 18 are arranged in the forward and aft cargo spaces 24, 25 and in the through-loading space 26 and in FIG. 11 three mobile additional tanks 63 are arranged in the through-loading space 26. According to FIG. 10, a cargo item 18 is arranged in the area of the landing gear 28 of aircraft 10, which has a maximum width in y-direction of 244 cm (96 inches). In the two other cargo spaces 24, 25, cargo containers 45 are arranged, which are wider in y-direction than the cargo items 18.

Furthermore, FIGS. 10 and 11 show in the area of the aircraft nose 29 and the aircraft tail 31 a further receiving device 66, especially a galley ring, to accommodate cargo items, especially kitchen utensils and/or luggage. The further receiving device 66 is ring-shaped in fuselage 11 and extends through the two decks 12, 13.

According to FIGS. 12 and 13, a cargo container 70 according to the invention is shown, which can be placed in the lower deck 13 of the aircraft 10 according to the invention. The cargo container 70 has a trapezoidal base body 71 with a base area 72 and a ceiling area 73, which are arranged opposite each other. The base area 72 comprises a fastening element 74, which can be connected to a fastening device of the aircraft 10.

The base area 72 forms a bottom end in the z-direction and the ceiling area 73 forms a top end in the z-direction of the cargo container 70. The base area 72 and the ceiling area 73 each comprise two longitudinal sides 75, 76, wherein the base area 72 has two first longitudinal sides 75 of at least 240 cm (95 inches), in particular 243.8 cm (96 inches). The ceiling area 73 has two second longitudinal sides 76 of at least 315 cm (approx. 124 inches), in particular 317.5 cm (125 inches). The cargo container 70 has a total height 77 of at least 99 cm to a maximum of 130 cm (39.5 inches to 51 inches). The cargo container 70 can have a total height 77 of at least 102 cm to a maximum of 127 cm (40 inches to 50 inches). According to FIGS. 12 and 13, the cargo container 70 has a total height 77 of 114.5 cm (45 inches). Alternatively, the cargo container 70 can also have a maximum overall height 77 of 127 cm (50 inches). In addition, the cargo container 70 preferably has a depth of at least 119 cm to a maximum of 317.5 cm (approx. 47 inches to 125 inches). As shown in FIGS. 12 and 13, the cargo container 70 has a preferred depth of 153.5 cm (60.4 inches).

The cargo container 70 has two broad sides 78, which include an inclined section 79 towards the base area 72. The inclined section 79 has a height H3 in z-direction from 43 cm to 56 cm (17 inches to 22 inches), in particular from 47 cm to 51 cm (18.5 inches to 20 inches). Specifically, the inclined section 79 has a height H3 in the z-direction of approximately 50 cm (approx. 19.6 inches).

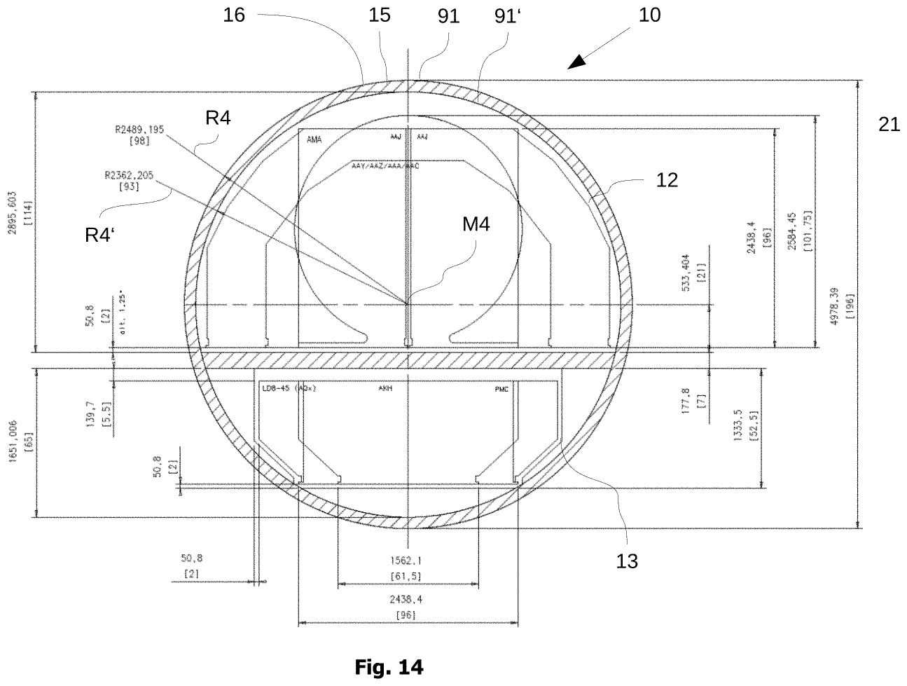

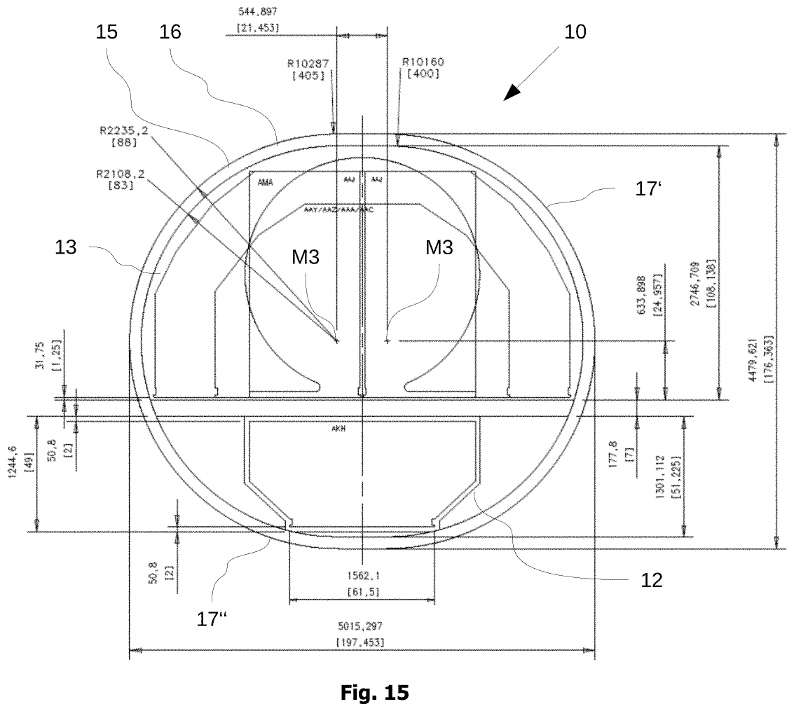

FIG. 14 shows a cross-sectional profile 16 of an aircraft 10 according to another exemplary embodiment according to the invention. Here the aircraft 10 is designed as a low-wing aircraft. In contrast to the cross-sectional profile 16 in FIG. 1, the cross-sectional profile 16 in FIG. 14 is designed circularly. In other words, the cross-sectional profile 16 according to FIG. 14 is formed by a single circle 91, 91′. The circle 91, 91′ has a center M4 from which the radius R4, R4′ of the circle extends. The barrel section 15, which includes the above-mentioned cross-sectional profile 16, has a wall thickness as described in FIG. 1. The barrel section 15, as shown in FIG. 14, has an outer maximum width of 497 cm (196 inches) in the y-direction and an outer maximum height 21 of 497 cm (196 inches) in the z-direction. Further dimensions of the cross-sectional profile 16 as well as loading configurations of the upper deck 12 and the lower deck 13 are shown in FIG. 14. The dimensions shown above the dimensions in the square brackets are given in millimeters. The dimensions shown in the square brackets below correspond to the inch value of the dimensions above in millimeters.

FIG. 15 shows a cross-sectional profile 16 of an aircraft 10 according to another exemplary embodiment according to the invention. Here the aircraft 10 is designed as a low-wing aircraft. The cross-sectional profile 16 according to FIG. 15 is designed oval in shape. The barrel section 15, which includes the cross-sectional profile 16 as mentioned above, has a wall thickness as described in FIG. 1. In contrast to the cross-sectional profile 16 according to FIG. 1, the first and the second circular arc sections 17′, 17″ of the cross-sectional profile 16 according to FIG. 15 can each have a straight section in the area of the z-axis of the aircraft 10.

The barrel section 15 as shown in FIG. 15 has an outer maximum width of 501.5 cm (approx. 197.5 inches) in the y-direction and an outer maximum height 21 of 447.9 cm (approx. 176.5 inches) in the z-direction. Further dimensions of the cross-sectional profile 16 and loading configurations of the upper deck 12 and the lower deck 13 are shown in FIG. 15. The dimensions shown above the dimensions in the square brackets are given in millimeters. The dimensions shown in the square brackets below correspond to the inch value of the dimensions above in millimeters.

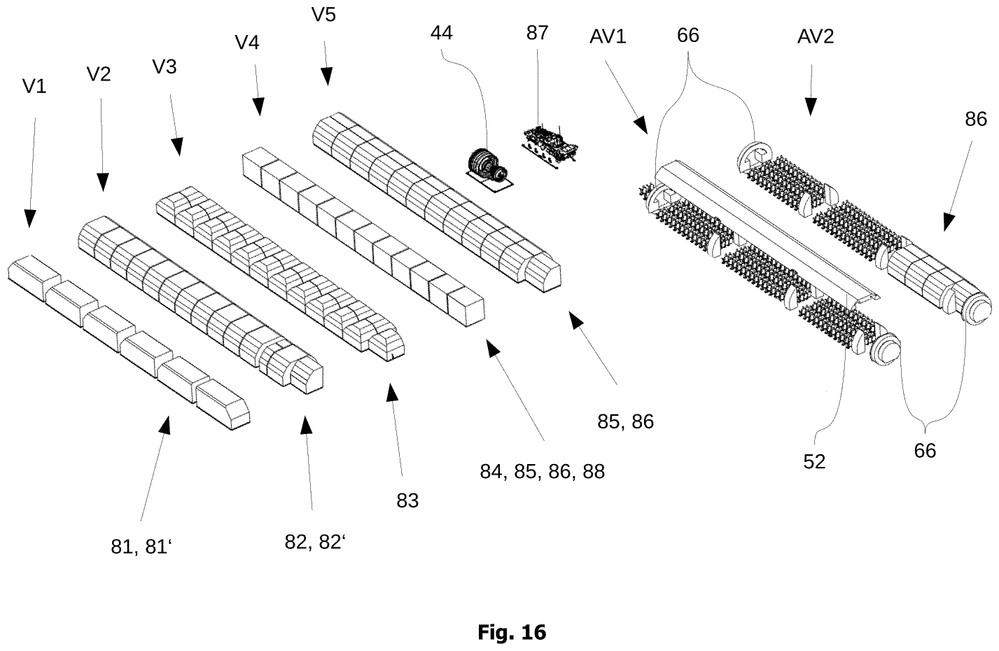

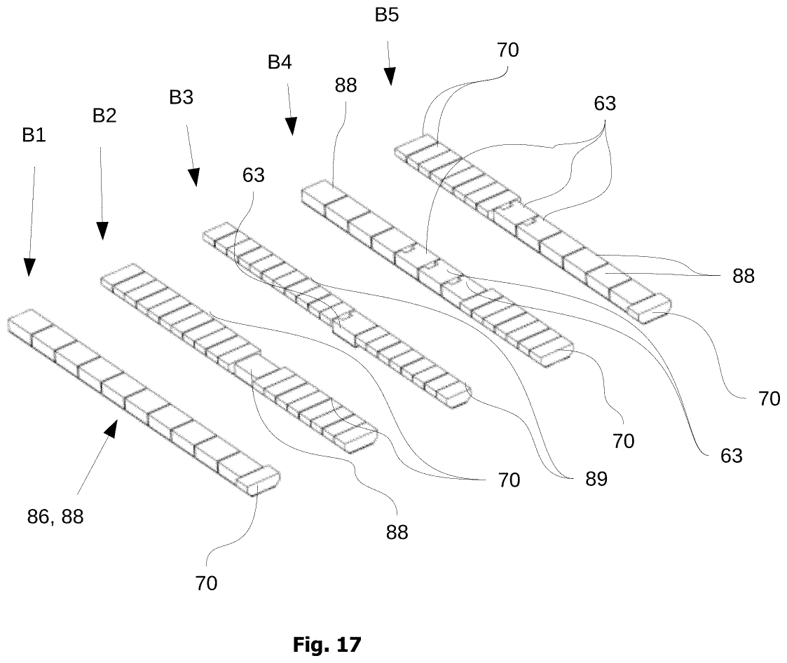

FIGS. 16 and 17 show several different loading/equipment configurations of the upper and lower decks 12, 13 of the aircraft according to FIG. 1, FIG. 14 and FIG. 15. Specifically, FIG. 16 shows several loading variants for aircraft 10 according to FIG. 1, FIG. 14 and FIG. 15, which are described below starting from the left. For a first loading variant V1, the aircraft 10 can accommodate six PGA pallets 81 with the basic dimensions 243.8×605.7 cm (96×238.5 inches) or six PRA pallets 81′ with the basic dimensions 243.8×497.8 cm (96×196 inches) one behind the other on the upper deck 12 in longitudinal direction of the aircraft.

With a second loading variant V2, the aircraft 10 can each accommodate, for example, twenty-five HCU-6E pallets 82 with the basic dimensions 223.5×274.3 cm (88×108 inches) and two HCU-12E pallets 82′ with the basic dimensions of 137.1×223.5 cm (54×88 inches) on the upper deck 12.

With a third loading variant V3, the aircraft 10 can each accommodate, for example, twenty-three AAC containers 83 with the dimensions 223.5×317.5×208.2 cm (88×125×82 inches) on the upper deck 12. The AAC containers 83 have a double contour. In this loading arrangement, the last AAC container 83 is loaded lengthwise in the longitudinal direction of the aircraft.

With a fourth loading variant V4, the aircraft 10 can each accommodate, for example, twelve AMA containers 84 with the basic dimensions 243.8×317.5×243.8 cm (96×125×96 inches) on the upper deck 12. It is conceivable that the aircraft 10 can each accommodate, for example, eleven AMA containers 84 with the dimensions 243.8×317.5×243.8 cm (96×125×96 inches) and one AAJ container 85 with the dimensions 223.5×317.5×243.8 cm (88×125×96 inches) or one PAG pallet 86 with the basic dimensions 223.5×317.5 cm (88×125 inches) on the upper deck 12. Alternatively, it is conceivable that the aircraft 10 can each accommodate, for example, twelve PMC pallets 88 with the basic dimensions 243.8×317.5 cm (96×125 inches) on the upper deck 12.

With a fifth loading variant V5, the aircraft 10 can each accommodate, for example, twenty-three AAJ containers 85 with the dimensions 223.5×317.5×243.8 cm (88×125×96 inches) or twenty-three PAG pallets 86 with the basic dimensions 223.5×317.5 cm (88×125 inches) on the upper deck 12. In addition, the aircraft 10 can each accommodate, for example, at least one aircraft engine 44 or at least one vehicle 87 on at least one PRA pallet 81′ or at least one PGA pallet 81 on the upper deck 12.

In a first configuration variant AV1, the aircraft 10 can have, for example, seven rows of seats, several sanitary areas and two receiving devices 66, especially galley rings, on the upper deck 12. The receiving devices 66 are described in FIGS. 10 and 11. In addition, the aircraft 10 may have a receiving device 52 for cargo items, especially baggage, in the ceiling area of the upper deck 12.

With a second configuration variant AV2, the aircraft 10 can accommodate, for example, seven PAG pallets 86 with basic dimensions of 223.5×317.5 (88×125) and a height of 243.8 cm (96 inches) on the upper deck 12 in addition to passenger seating. This configuration variant corresponds to a combination configuration of aircraft 10, which combines a cargo configuration and a passenger configuration of aircraft 10.

FIG. 17 shows several loading variants for the aircraft 10 according to FIG. 1 and FIG. 14, which are described in the following starting from the left. For a first loading variant B1, the aircraft 10 can accommodate, for example, several PMC pallets 88 with the basic dimensions 243.8×317.5 cm (96×125 inches) loaded one behind the other in the longitudinal direction of the aircraft or several PAG pallets 86 with the basic dimensions 223.5×317.5 cm (88×125 inches) loaded one behind the other in the longitudinal direction of the aircraft on the lower deck 12. A PMC pallet can be arranged in the through-loading space. With this loading arrangement, the last cargo item in the longitudinal direction of the aircraft may be a cargo container 70, as described in FIGS. 12 and 13, in the aft cargo space.

With a second loading variant B2, the aircraft 10 can alternatively accommodate, for example, several cargo containers 70 loaded one behind the other in the longitudinal direction of the aircraft on the lower deck 12 as shown in FIGS. 12 and 13, wherein a PMC pallet 88 or at least one mobile additional tank 63 with the basic dimensions of a PMC pallet 88 is arranged in the through-loading space.

With a third loading variant B3, the aircraft 10 can each accommodate several containers 89, in particular AKH containers, having the basic dimensions of 153.4 cm×156.2 (60.4×61.5 inches) loaded one behind the other in the longitudinal direction of the aircraft, for example, on the lower deck 12, wherein a PMC pallet 88 or at least one mobile additional tank 63 with the basic dimensions of a PMC pallet 88 is arranged in the through-loading space 26.

With a fourth loading variant B4, the aircraft 10 can each accommodate, for example, several cargo containers 70 loaded one behind the other in the longitudinal direction of the aircraft as shown in FIGS. 12 and 13 in the aft cargo space, as well as several PMC pallets 88 loaded one behind the other in the forward cargo space and several three mobile auxiliary tanks 63 in the area of the through-loading space 26 on the lower deck 12. The mobile additional tanks 63 can have the basic dimensions of a PMC pallet 88. With a fifth loading variant B5, the aircraft 10 can accommodate several cargo containers 70 loaded one behind the other in the longitudinal direction of the aircraft as shown in FIGS. 12 and 13 in the forward cargo space, and several PMC pallets 88 loaded one behind the other in the aft cargo space and two mobile additional tanks 63 in the area of the through-loading space on the lower deck 12. The mobile additional tank 63 can have the basic dimensions of a PMC pallet 88. With this loading variant, the last cargo item in the longitudinal direction of the aircraft can be a cargo container 70, as described in FIGS. 12 and 13, in the aft cargo space. Further arrangements of the containers and pallets in the area of the forward and aft cargo space are directly recognizable in FIG. 17 with regard to the aforementioned loading variants.

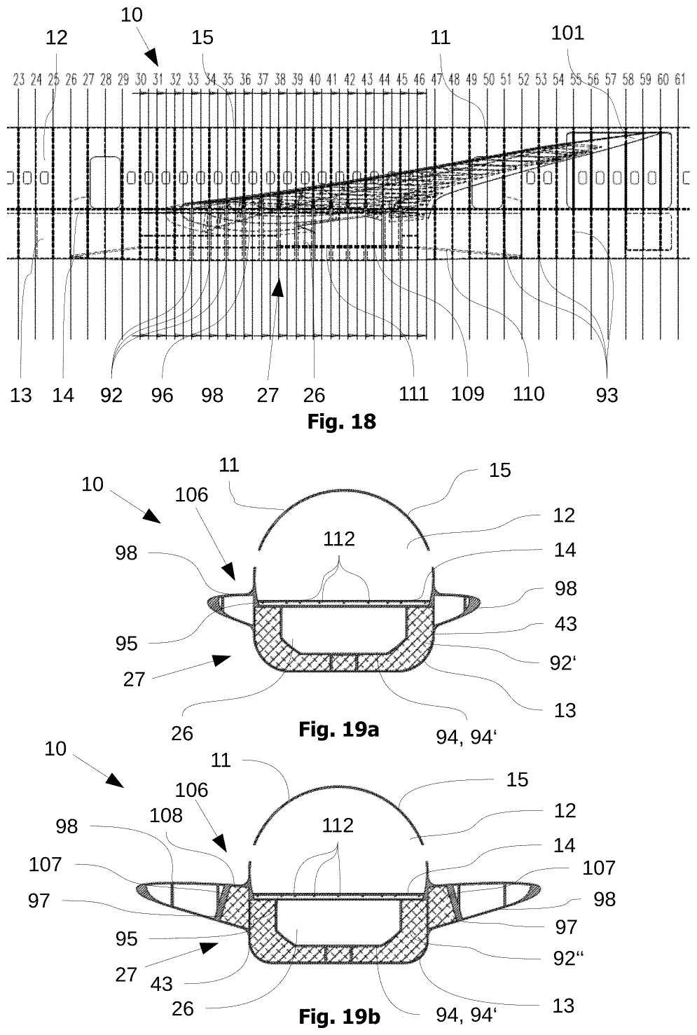

FIG. 18 shows a section of a side view of an aircraft 10 according to another exemplary embodiment according to the invention, wherein the section represents the aircraft 10 in a wing area. FIG. 18 shows a sequential numbering “23” to “61”, wherein one number is assigned to each frame 93 of the fuselage structure 38. In the wing area, additional lines of intersection are shown between frames 93, which can be recognized by the arrows shown on the lines at the top and bottom. The intersections along the lines of intersection will be discussed in detail later.

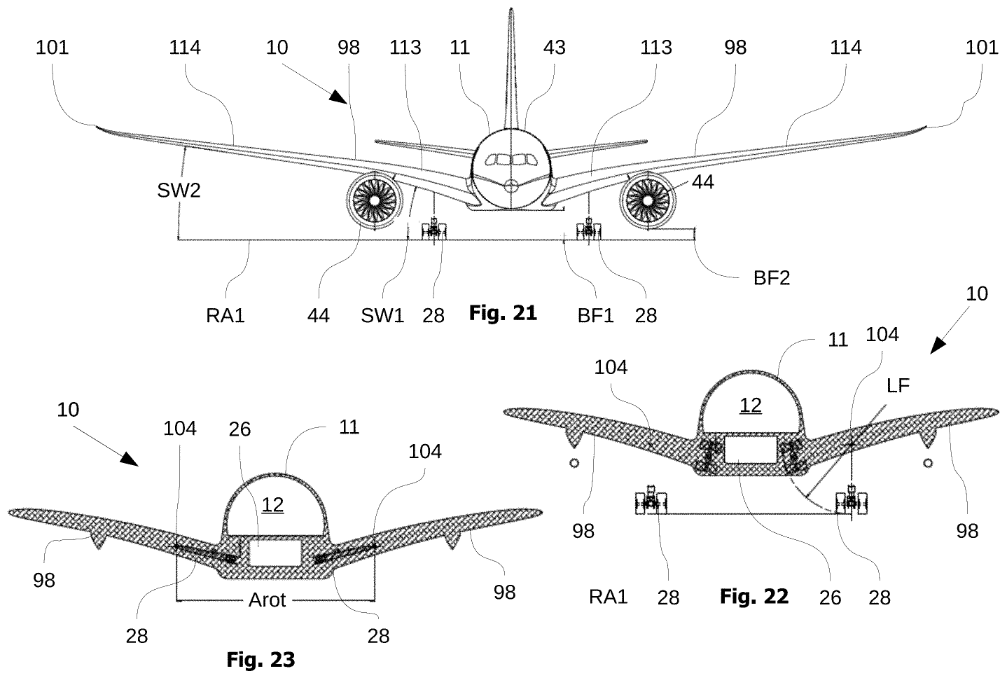

The aircraft 10 according to FIG. 18 has a fuselage 11 with a barrel section 15 connected to two wings 98. In general, the aircraft 10 comprises an upper deck 12 and a lower deck 13, separated by a floor 14. The aircraft 10 is designed as a low-wing aircraft and has two aircraft engines 44, with one of the aircraft engines 44 located below on each of the wings 98. This is clearly visible in FIG. 21, for example.

The barrel section 15 comprises a wing box 27, which is located in the lower deck 13 between the wings 98 in y-direction. The wing box 27 is fixed to the wings 98 and forms a stiffening structure to transfer forces from the wings 98 to the fuselage structure 38 of the aircraft 10. For the connection with the wings 98, the wing box 27 has a wing connection area 106 on both sides, which will be discussed in detail later.

The wing box 27 has several plates 92 extending transversely to the longitudinal direction of the aircraft. The plates 92 are spaced from each other in the longitudinal direction of the aircraft. Specifically, one plate 92 is arranged at each frame 93 of the fuselage structure 38 of the barrel section 15. In other words, the distances between the plates 92 in the longitudinal direction of the aircraft correspond to the distances between the frames 93. The plates 92 are firmly attached to the frames 93. It is possible that the plates 92 are integrally formed with the frames 93. In other words, the plates 92 can be integral with the frames 93.

Plates 92 are made in one piece, i.e. integrally. It is possible that at least one of the plates 92 is formed from several individual plate parts.

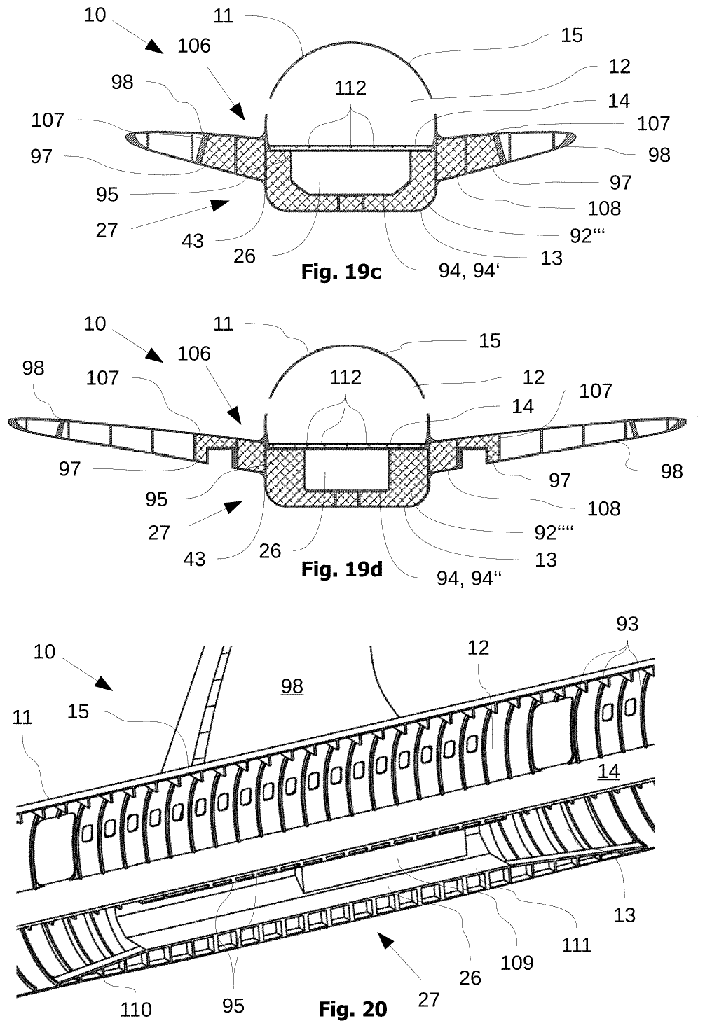

The plates 92 can have different cross-sectional shapes depending on their position in wing box 27. FIGS. 19a to 19d show exemplary cross-sections through barrel section 15 to illustrate the arrangement or the cross-sectional shape of the plates 92 (cross-hatching) which changes in the longitudinal direction.

FIG. 19a shows a section between two frames 93 with the numbering “32” and “33”, looking towards the tail 31 of the aircraft. FIG. 19a shows a first plate 92′, which is arranged in the area of the wing root in longitudinal direction of the aircraft. The plate 92′ is essentially U-shaped. The plate 92′ fills a space which is limited by a through-loading space 26, a fuselage skin 43 and a crossbeam 95 of the floor 14.

FIG. 19b shows a section between two frames 93 with the numbering “34” and “35” looking towards the tail 31 of the aircraft. FIG. 19b shows a second plate 92″, which is also located in the area of the wing root in longitudinal direction of the aircraft.

In contrast to the first plate 92′, the second plate 92″ has two plate ends 107, each of which extends into one of the wings 98. The plate ends 107 are directly adjacent to an inner contour 108 of the wings 98.

As shown in FIG. 19c, a further section is shown, which extends between the two frames 93, numbered “35” and “36”. The figure shows a third plate 92′″ which, in contrast to the second plate 92″, has plate ends 107 which are longer in the y-direction than the plate ends 107 of the second plate 92″. In other words, the plate ends 107 of the third plate 92′″ extend further into the wings 98 than the plate ends 107 of the second plate 92″. The plate ends 107 of the third plate 92′″ are also directly adjacent to the inner contour 108 of the wings 98.

FIG. 19d shows a fourth plate 92″, which can be seen by a section between two frames 93 with the numbering “39” and “40”. The fourth plate 92″ is located in the area of landing gears 28, which can be clearly seen in FIG. 21. The fourth plate 92″ has 107 downwardly open recesses 108 at the panel ends to accommodate the landing gears 28. The axes of rotation of the landing gears 28 are embedded in the ends of the plates 107 in order to achieve direct force transmission into the wing box 27. In other words, the plate ends 107 of the fourth plate 92″ protrude above the axes of rotation of the landing gears 28 in the y-direction of the aircraft 10.

The four plates 92′, 92″, 92″, 92″ are only examples of the structure of the plurality of plates 92 at certain positions in the wing box 27. The wing box 27 contains more than four plates 92, as shown in FIGS. 18 and 20. The respective cross-sectional shape of the plates 92 depends on the position of the plates 92 in the longitudinal direction of the aircraft, the inner contour 108 of the wings 98 and the cargo space cross-section of the through-loading space 26 at the corresponding position.

The wing box 27 according to FIG. 18 has a total of thirteen plates 92. Alternatively, wing box 27 can have more or less than thirteen plates 92. Some of the plates 92 have, as described above, plate ends 107 extending on both sides in the y-direction and projecting into the two wings 98. The plate ends 107 form a wing connection area 106 at the barrel section 15 to which the wings 98 are attached. As shown in FIGS. 19b-d, the wings 98 are pushed or plugged onto the plate ends 107 of the plates 92. The plate ends 107 of the plates 92 form a common mounting stub 97 on each transverse side of the barrel section 15, onto which the wings 98 are plugged. The respective mounting stub 97 engages in the corresponding wing 98 in a fan shape. The wings 98 are positively connected to the respective mounting stub 97. In addition, the wings 98 can be connected to the respective mounting stub 97 in a force-locking and/or materially bonded manner. Preferably, the wings 98 are additionally flanged to the wing connection area 106.

As can be seen in FIGS. 19a-d, the plates 92 each have a passage opening 94. Plates 92, which are located in the longitudinal direction of the aircraft outside a side landing gear compartment 109, have first openings 94′, which are the same.

This is clearly visible in FIGS. 19a-c. The plates 92 with the first passage openings 94′ are arranged in the longitudinal direction of the aircraft in such a way that the first passage openings 94′ are aligned.

The plates 92, which are located in the longitudinal direction of the aircraft within a lateral receiving space 109 for the landing gear 28, have second passage openings 94″, which are the same. The plates 92 with the second passage openings 94″ are arranged in the longitudinal direction of the aircraft so that the second passage openings 94″ are aligned. The shape and width of the first openings 94″ differ from the shape and width of the second passage openings 94″. The second passage openings 94″ of the plates 92 are smaller in y-direction than the first openings 94″ of the corresponding plates 92.

The width of the second passage openings 94″ is limited laterally by the receiving space 109 for the landing gears. The through-loading space 26, which extends through the passage openings 94′, 94″, is narrowed in the area of the lateral receiving space 109. This can be seen in the longitudinal sectional view of the aircraft 10 according to FIG. 20.

FIG. 20 also shows that a ramp 110 is arranged at the nose and tail towards the through-loading space 26, which leads to a raised level 111 of the wing box 27. Below level 111, the plates 92 extend transversely through the barrel section 15. The ramps 110 are preferably used to stabilize the transition between the wing box 27 and the fuselage structure 38 which is connected in longitudinal direction.

The wing box 27 also has several crossbeams 95 extending in the y-direction, which are arranged above the plates 92 in the z-direction and interact with the plates 92 to reinforce the fuselage structure 38 (see FIGS. 19-20). The crossbeams 95 form the part of the cross-bracing structure of the wing box 27 that is located at the top in z-direction. Compared to crossbeams of the fuselage structure 38 of the adjacent barrel sections, which are located outside the wing box 27 in the longitudinal direction of the aircraft, the crossbeams 95 are reinforced to absorb increased forces.

The crossbeams 95 of the wing box 27 are connected to the plates 92 in a force-transmitting manner. Together with the plates 92, the crossbeams 95 form a particularly stable stiffening unit. The crossbeams 95 stiffen the fuselage structure 38 of the barrel section 15 in y-direction. The crossbeams 95 support the frames 93 in y-direction in the wing area.

The wing box 27 also has several longitudinal beams 96 extending in the longitudinal direction of the aircraft, which connect the crossbeams 95 to each other. The longitudinal beams 96 connect the crossbeams 95 to each other in the longitudinal direction of the aircraft. Together with the crossbeams 95, the longitudinal beams 96 form a grid structure which is arranged above the plates 92 in the z-direction. The longitudinal beams 96 are arranged over the length of the wing box 27. All in all, the wing box 27 with the plates 92 and the crossbeams and longitudinal beams 95, 96 form a very stable structure which is the stiffest part of the fuselage structure 38 of the entire aircraft 10.

Seat rails 112 are arranged horizontally on the longitudinal beams 96 in order to provide appropriate seating on the upper deck 12 or to secure cargo items. The seat rails 112 are hinged to the seat rails of the adjacent barrel sections 15 in the two transition areas in the longitudinal direction of the aircraft where the wing box 27 merges with the adjacent barrel sections 15. The articulated connection enables a pivoting movement of the seat rails of the adjacent barrel sections in z-direction. This can be the case especially during flight operations.

FIG. 21 shows a front view of aircraft 10 according to FIG. 18, with the wings 98 showing an angled wing shape. Starting from the wing connection area 106, the wings 98 extend outwards transversely to the longitudinal direction of the aircraft to a free wing tip 101. The wings 98 have an area 113 close to the fuselage and a an area 114 remote from the fuselage. In the area 113 close to the fuselage the wings 98 extend in a first angle of inclination SW1, which is larger than a second angle of inclination SW2, in which the wings 98 extend in the area 114 remote from the fuselage towards the free wing tip 101. The angles of inclination SW1, SW2 refer to a reference axis RA1, which extends in the y-direction of the aircraft 10.

On aircraft 10 as shown in FIG. 21, the first angle of inclination SW1 is between 16 degrees and 18 degrees. The second angle of inclination SW2 is between 7 degrees and 10 degrees.

As can be seen in FIGS. 21 to 23, the landing gears 28 are located in the area near the fuselage 113 and the aircraft engines 44 in the area remote from the fuselage 114. The aircraft 10 according to FIG. 18 has an outer maximum height of the fuselage 11 or barrel section 15 of approximately 485 cm (191 inches) and an outer maximum width of approximately 498 cm (196 inches). The landing gears 28 of aircraft 10 have axes of rotation 104 in y-direction with a distance Arot of approximately 955 cm (376 inches). With a length LF of the landing gears 28 of approximately 335 cm (132 inches), the through-loading space 26 in the area of the receiving space 109 of the landing gears 28 has a clear width in y-direction of 254 cm (100 inches). The clear height of the through-loading space 26 in the area of the landing gears 28 is approximately 128 cm (approx. 50.5 inches). The landing gear length LF is measured from the axes of rotation 104 to the lower edge of the landing gear wheels.

Due to the two protruding angles of inclination SW1, SW2 of the wings 98, the aircraft 10 has a first ground clearance BF1 in z-direction from a lower edge of the fuselage 11 to a lower edge of the landing gears 28 in the folded-out condition of approximately 186 cm (approx. 173 inches) according to FIG. 18. When using aircraft engines 44 with a rotor diameter of approximately 265 cm (approx. 104.5 inches) with corresponding arrangement at the wings 98, a second ground clearance BF2 in z-direction from a lower edge of the engines 44 to a lower edge of the landing gears 28 of between 69 cm and 72 cm (approx. 27 inches and approx. 28 inches), preferably approximately 700 cm (approx. 27.5 inches), can be achieved.

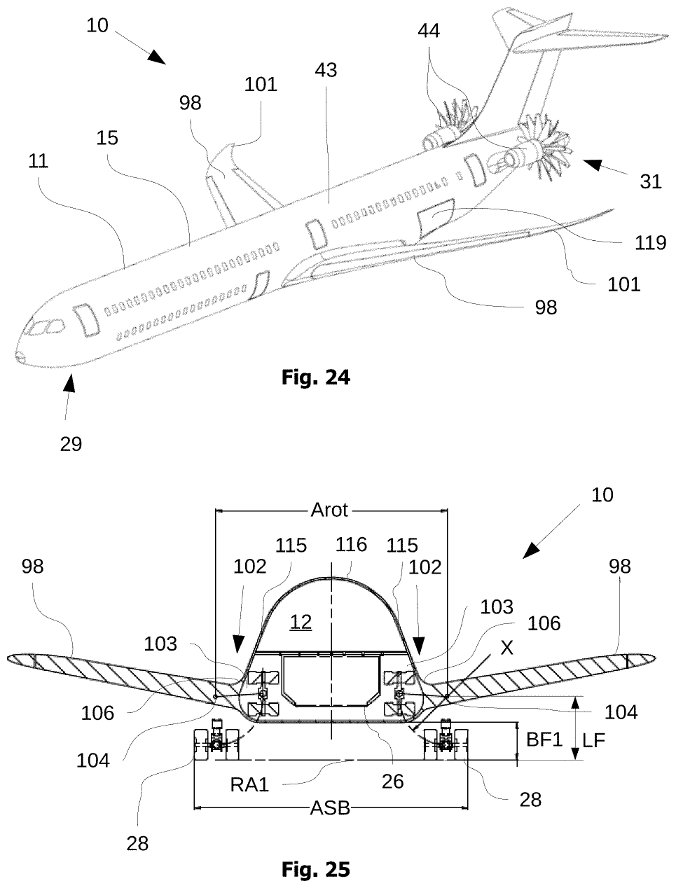

According to FIG. 24, an aircraft 10 is shown according to another exemplary embodiment according to the invention, which has a fuselage 11 with a barrel section 15 connected to two wings 98. In general, the aircraft 10 has an upper deck 12 and a lower deck 13 separated by a floor 14. The aircraft 10 is designed as a low-wing aircraft and has two aircraft engines 44. In contrast to the aircraft shown in FIG. 18, however, the aircraft engines 44 are not located on the wings 98, but on the tail 31. Furthermore, there is no bend in the curves of the wings 98, which have a constant shape as shown in FIG. 25.

The aircraft 10 according to FIG. 24 has a wing box 27 with plates 92, which corresponds to the wing box 27 as described in FIGS. 18 and 19a-d. By contrast, however, the plates 92 of the wing box 27 as shown in FIG. 24 (not visible) have a passage opening 94 for the through-loading space 26, which are identical. The through-loading space 26 of the aircraft 10 according to FIG. 24 has a through-loading cross-section which is identical to the cross-sections of the cargo space adjoining the forward and aft cargo space. In other words, the forward and aft cargo spaces together with the through-loading space 26 form a common cargo space 105, which has a constant continuous cross-section between the nose and the tail of the aircraft 10.

According to FIG. 25, the landing gears 28 are shown in folded-in and folded-out condition for the sake of simplicity. As can be seen in FIG. 25, the landing gears 28 are arranged close to the fuselage.

The aircraft 10 as shown in FIG. 24 has an outer diameter of the fuselage 11 or barrel section 15 of approximately 477 cm (188 inches). The landing gears 28 of aircraft 10 have axes of rotation 104, which have a distance Arot of 775 cm (approx. 305 inches) in y-direction. With a length LF of the landing gears 28 of approximately 212 cm (83.7 inches), the through-loading space 26 in the area of the receiving space 109 of the landing gears 28 has a clear width in y-direction of 328 cm (approx. 129 inches). The landing gear length LF is measured from the axes of rotation 104 to the lower edge of the landing gear wheels. The distance X from the axes of rotation 104 to the rotation axis of the landing gear wheels is approximately 161 cm (63.3 inches).

The aircraft 10 according to FIG. 24 has a ground clearance BF1 in z-direction from a lower edge of the fuselage 11 to a lower edge of the landing gears 28 in the folded-out position of approximately 125.5 cm (approx. 49.5 inches). Furthermore, the landing gears 28 together have an outer track width ASB of approximately 914 cm (360 inches). The outer track width ASB corresponds to the maximum track width when the landing gears 28 are folded out.

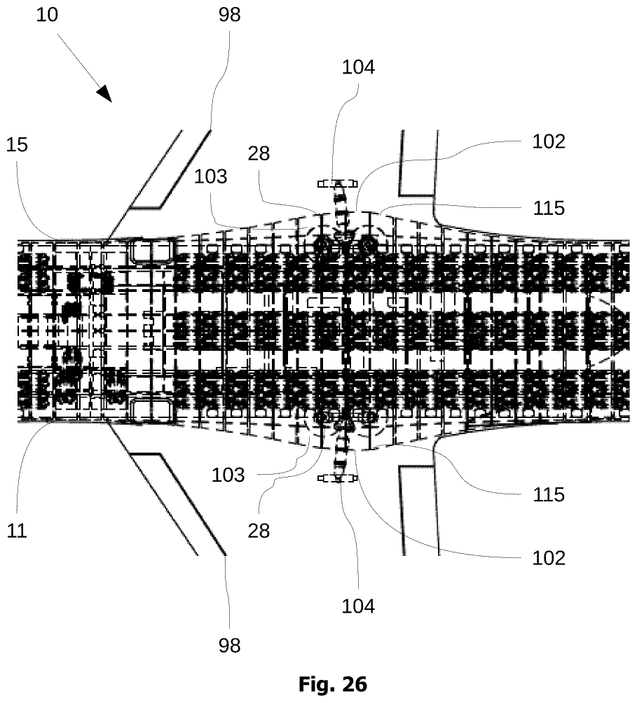

FIG. 26 shows a top view of the aircraft 10 according to FIG. 24, wherein the outer fuselage skin 43 is not shown. The fuselage 11 has a fuselage structure extension 102 on both sides in y-direction to accommodate the landing gears 28. In other words, the barrel section 15 has a bulge on both sides in the longitudinal direction of the aircraft in the area of the landing gears 28 at the outer contour in y-direction. Due to the fuselage structure extension 102, the cross-sectional profile of barrel section 15 is wider in the area of the landing gears 28 than outside the area of the landing gears 28. Due to the fuselage structure extension 102, a free space 103 is formed on one wing side in the lower deck 13 to accommodate the landing gears 28. In other words, the free space 103 is used to stow the landing gears 28. The fuselage structure extension 102 is formed in the area of the wing box 27. The free space 103 is embedded in the wing box 27. This means that the plates 92 of the wing box 27 are exposed in the area of free space 103 in the y-direction from the outside to the inside, in particular cut out to allow the landing gears 28 to be folded in.

As shown in FIG. 25, in cross-section the fuselage structure extension 102 in the area of the landing gears 28 is formed by a straight extension 115 of an upper, circular-segment-shaped fuselage segment 116 of the barrel section 15 towards the wing connection area 106. The straight extension 115 is formed as a tangent of the circular-segment-shaped fuselage segment 116 towards the wing 98. The straight extension 115 extends diagonally outwards in the y-direction and thus widens the cross-section of the barrel section 15 in the lower deck 13, so that the free space 103 is formed.

In FIG. 26 the drawing clearly shows that the fuselage structure extension 102 in longitudinal direction of the aircraft is formed in a tail area of the wings 98. The straight extension 115 of the upper fuselage segment 116 leads diagonally outwards from upper deck 12 to lower deck 13. The free space 103 is formed between the outer fuselage skin 43 and the through-loading space 26 in such a way that the cargo space cross-section of the through-loading space 26 is the same as the forward and aft cargo spaces. In other words, the free space 103 is such that the through-loading space 26 does not have a cross-section narrowing in the y-direction with respect to the forward and aft cargo spaces. This can be seen, for example, in FIG. 25, wherein a cargo item is arranged in the through-loading space 26 for illustration purposes only.

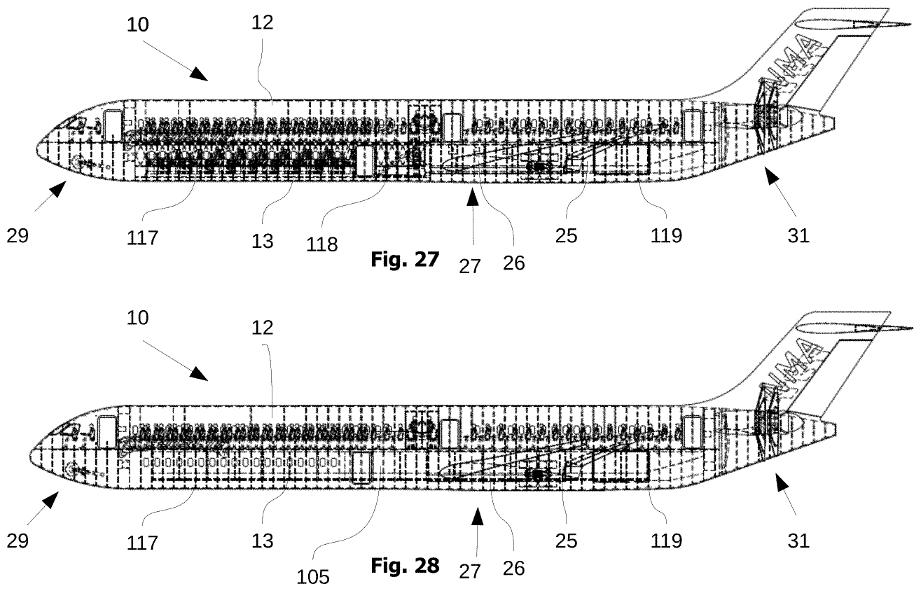

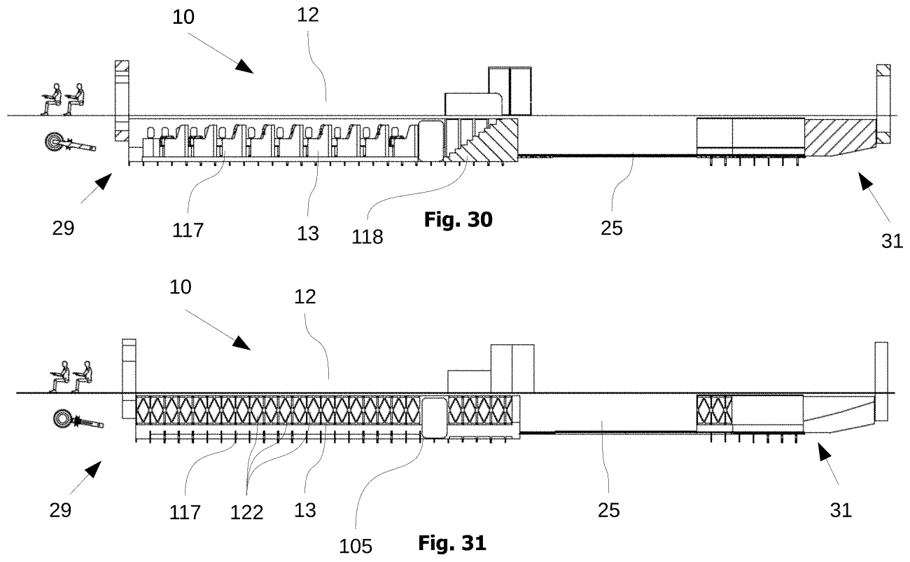

FIGS. 27 to 29 each show a variant with a deck configuration of aircraft 10 according to FIG. 24. FIG. 27 shows a first deck configuration of aircraft 10. In concrete terms the aircraft is shown in a configuration in which a passenger seating, e.g. for approximately 200 passengers, is arranged in the entire upper deck 12 and passenger seating, e.g. for approximately 60 to 70 passengers, is arranged in the lower deck 13 in a forward fuselage area 117, i.e. in the longitudinal direction of the aircraft in front of the through-loading space 26, especially the wing box 27. The through-loading space 26 and the aft cargo space 25 are equipped for the transport of cargo and therefore do not have any passenger seating. In the passenger areas of the upper and lower decks 12, 13 there are rows of windows on both sides. To connect the two decks 12, 13 a staircase 118 is arranged in the area of the forward wing attachment. Sanitary facilities may also be provided in this area. In this case, it is advantageous to divide the passengers between the upper and lower decks 12, 13 to shorten the length of the aircraft 10. The passenger seating on the lower deck 13 and staircase 118 is clearly visible in FIG. 30, wherein FIG. 30 does not show the aircraft structure, i.e. outer skin, frames, wing box, etc., or the passenger seating on the upper deck 12 for better illustration.

In addition, as shown in FIG. 24, the aircraft 10 has an aft loading door 119 through which the aft cargo space 25 is accessible for loading and unloading the lower deck 13. There is no forward loading door provided for loading the lower deck 13. Compared to a forward loading door, the aft loading door 119 has the advantage that in the first deck configuration of the aircraft 10 it prevents an undesired draft in the cabin, thus increasing the comfort for the passengers during flight.

Furthermore, the aft loading door 119 is located on one side of the aircraft, which is on the left side when looking from the tail 31 to the nose 29 of the aircraft. This has the advantage that the loading or unloading process is simplified by means of a ramp vehicle.

As the aircraft 10 according to FIG. 24 has a cargo space with a constant cross-section over the entire length of the fuselage 11, i.e. from the tail 31 of the aircraft to the nose 29 of the aircraft, reconfiguration of the lower deck 13 is considerably simplified.

For example, FIG. 28 shows a second deck configuration which differs from the first deck configuration shown in FIG. 27 only in that the forward fuselage area 117 is converted to a forward cargo space 24. In other words, the forward fuselage area 117 is set up as a cargo space to transport cargo items. In the second deck configuration, the aircraft 10 thus has a seated upper deck 12 for passenger transport and a lower deck 13 for cargo transport.

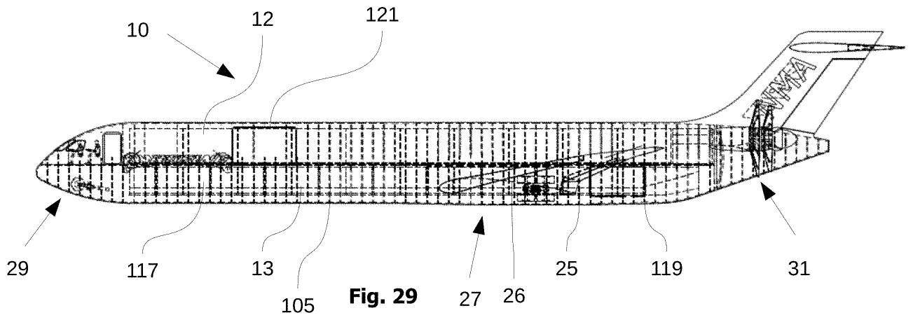

In a third deck configuration, shown in FIG. 29, aircraft 10 is designed for pure cargo transport. For this purpose, the upper deck 12 and the lower deck 13 are each set up as cargo spaces for transporting cargo items. In addition, the aircraft 10 in the cargo configuration has a forward loading door 121 through which the cargo space of the upper deck 12 is accessible for loading and unloading. Seating on the upper and lower decks 12, 13 is missing in the third deck configuration.

In the second and third deck configuration, the lower deck 13 is formed as shown in FIG. 31. In other words, the lower deck 13 is intended for cargo transport only.

In the lower deck 13, the passenger seating and staircase 18 are missing here. Furthermore, the aircraft structure, i.e. outer skin, frames, wing box, etc., is not shown in FIG. 31 for better illustration. In FIG. 31 it is also evident that unfolded cargo space modules 122 are introduced to form the cargo space, which will be discussed in more detail below.

A great advantage of the aircraft 10 according to FIG. 24 results from the fact that the lower deck 13 has a cargo space that is continuous from tail to nose with a constant cargo space cross-section, especially cargo space profile. This allows a reconfiguration of the lower deck 13 by means of foldable cargo space modules quickly and easily. The cargo space modules can be designed in such a way that they replace vertical frames of the fuselage structure 38 of the aircraft 10. When reconfiguring the lower deck 13, for example to a cargo space for cargo items or to a passenger cabin, the foldable cargo space modules can be brought into the lower deck 13 via the aft loading door 119 and arranged in a row one behind the other. The cargo space modules can be combined in any desired way, for example to create a lower deck 13 according to the first deck configuration, second or third deck configuration.

The foldable cargo space modules can, for example, be fitted with pre-assembled seat rails for the subsequent attachment of a passenger seat, or with a pre-assembled passenger seat in the lower deck 13. For the configuration of the lower deck 13 as a cargo-only area, the cargo space modules may have pre-assembled devices for securing and guiding cargo items.

With regard to the foldable cargo space module, reference is made to application DE 10 2019 132 292.8, which is already mentioned in the introduction to the description.

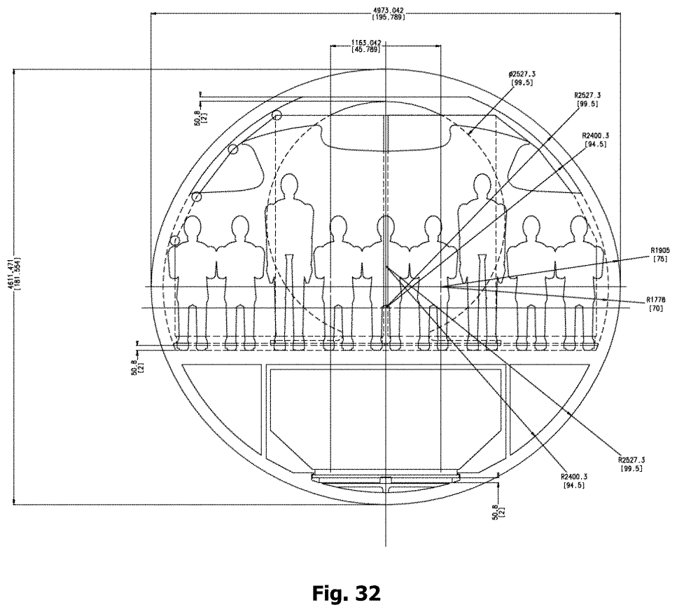

FIG. 32 shows a cross-sectional profile 16 of an aircraft 10 according to another exemplary embodiment according to the invention. In this example, the aircraft 10 is designed as a low-wing aircraft. The cross-sectional profile 16 according to FIG. 32 is oval. The barrel section 15, which includes the cross-sectional profile 16 as mentioned, has a wall thickness as described in FIG. 1.

The barrel section 15 as shown in FIG. 32 has an outer maximum width of 497 cm (approx. 196 inches) in the y-direction and an outer maximum height 21 of 461 cm (approx. 181 inches) in the z-direction. Further dimensions of the cross-sectional profile 16 as well as loading configurations of the upper deck 12 and the lower deck 13 are shown in FIG. 32. The dimensions shown above the dimensions in the square brackets are given in millimeters. The dimensions shown in the square brackets below correspond to the inch value of the dimensions above in millimeters.

The aircraft 10 as shown in FIG. 32 may be configured in several different loading/equipment configurations of the upper and lower decks 12, 13 as shown and described in FIGS. 16 and 17, like the aircrafts shown in FIG. 1, FIG. 14 and FIG. 15. Reference is hereby made to the loading variants V1 to V5 and the equipment variants AV1 and AV2 as described above.

At this point, it should be noted that all parts described above, in particular also the embodiments and/or exemplary embodiments themselves, each for itself—even without features additionally described in the respective context, even if these are not explicitly identified individually as optional features in the respective context, e.g. by using: in particular, preferably, for example, e.g., if necessary, round brackets, etc.—and in combination or any sub-combination are to be regarded as independent designs or further developments of the invention, as defined in particular in the introduction to the description and the claims. Deviations from this are possible. Specifically, it should be noted that the word in particular or round brackets do not indicate any features that are mandatory in the respective context.

Furthermore, it should be noted that the term ‘wing box’ in this application is by no means to be understood as meaning a conventional wing box as it has been used in aircraft construction for more than 50 years. Rather, the wing box of the present application is a functional unit that serves to absorb the forces acting on the wings.

In the embodiments and exemplary embodiments, reference is mainly made to the plates. The individual explanations and/or advantages are also applicable to the C-shaped beams. With regard to the additional or alternative design of the plates, reference is made to the embodiments of the plates mentioned in the introduction to the description.

### LIST OF REFERENCE NUMERALS

10 Aircraft
11 Fuselage
12 Upper deck
13 Lower deck
14 Floor
15 Barrel section
16 Cross-sectional profile
17 Circular arc sections
17′ First circular arc section
17″ Second circular arc section
17′″ Third circular arc sections
18 Cargo item/container
18′ First cargo container
18″ Second cargo container
18′″ Third cargo container
19 Outer maximum width
21 Outer maximum height
22 First clear width
23 Second clear width
24 Forward cargo space
25 Aft cargo space
26 Through-loading space
27 Wing box
28 Landing gear
29 Aircraft nose
31 Aircraft tail
32 Minimum width of the through-loading space
32′ Minimum usable width of the through-loading space
33 Through-loading height
34 Seating rows
35 Corridors
36 First loading door
37 Second loading door
38 Fuselage structure
39 Forward loading opening
41 Upper edge of the floor
42 Lower edge of the floor
73 Outer fuselage skin
44 Aircraft engine
45 Trapezoidal cargo containers
46 Pallet
47 Floor structure
48 Roller conveyor system
49 Clear width of the upper deck
51 Clear width of the lower deck
52 Receiving device
53 Ceiling area
54 Central area
55 Common area
56 First area
57 Second area
58 Walking Area
59 First clear width
61 Second clear width
62 Third clear width
63 Mobile additional tank
64 Fuel tank
65 Doors
66 Additional receiving device
67 Tail loading opening of the lower deck
67′ Tail loading opening of the upper deck
70 Cargo container
71 Trapezoidal base body
72 Base area
73 Ceiling area
74 Fastening element
75 First longitudinal side
76 Second longitudinal side
77 Total height
78 Broad sides
79 Inclined section
81 PGA pallets
81′ PRA pallets
82 HCU-6E pallets
82′ HCU-12E pallets
83 AAC container
84 AMA container
85 AAJ container
86 PAG pallets
87 Vehicle
88 PMC pallet
89 AKH container
91 Circle
92 Plate
92′ First plate
92″ Second plate
92′″ Third plate
92″ Fourth plate
93 Frames
94 Passage opening
94′ First passage opening
94″ Second passage opening
95 Crossbeam
96 Longitudinal beam
97 Mounting stubs for wings
98 Wing
99 -
101 Free wingtip
102 Fuselage structure extension
103 Free space
104 Axes of rotation
105 Common cargo space
106 Wing connection area
107 Plate ends
108 Inner contour of the wings
109 Lateral receiving space
110 Ramp
111 Raised level
112 Seat rails
113 Area close to the fuselage
114 Area remote from the fuselage
115 Extension
116 Fuselage segment
117 Forward fuselage area
118 Staircase
119 Aft loading door
121 Forward loading door
122 Foldable cargo space modules
A1′ Distance of the floor to the y-axis
A1″ Distance of the center of the first circular arc section
A2 Distance of the center of the second circular arc section from the center of the first circular arc section
A3 Distance of the center of the second circular arc section from the upper edge of the floor
A4 Distance between the centers of the third circular arc sections
A5 Minimum distance
A6 Distance between the central area and the upper edge
A7 Distance between the axes of rotation
R1′, R2′,
R3′, R4′ Outer radii
R1, R2,
R3, R4 Radii
M1, M2,
M3, M4 Centers
H1 Height of the first and second cargo container
H2 Height of the trapezoidal cargo container and pallet
H3 Height of the inclined section
V1, V2, V3,
V4, V5 Loading variants of the upper deck
AV1, AV2 Equipment variants of the upper deck
B1, B2, B3,
B4, B5 Loading variants of the lower deck
Arot Distance between the axes of rotation
ASB Outer track width
BF1 First ground clearance
BF2 Second ground clearance
LF Length of landing gear
RA1 Reference axis
SW1, SW2 Angle of inclination
X Distance of the axes of rotation from the rotation axis of the landing gear wheels

1. An aircraft for transporting cargo and/or passengers, comprising a fuselage which extends in the longitudinal direction and has an upper deck, in particular main deck, and a lower deck, which are separated from each other by a floor, wherein the fuselage has a barrel section with a cross-sectional profile for accommodating cargo items and/or passengers,
wherein
the cross-sectional profile is essentially formed by a plurality of, in particular four, circular arc sections, which have radii (R1, R2, R3) with centers (M1, M2, M3′, M3″) differing from one another, so that the cross-sectional profile is designed in such a way that cargo items with different sizes, in particular cargo containers with different height and width dimensions, can be accommodated in the upper deck and the lower deck.

2. The aircraft according to claim 1, wherein the cross-sectional profile of the fuselage is oval in shape, wherein the fuselage has an outer maximum width of 490 cm to 510 cm in the y-direction and an outer maximum height of 480 cm to 500 cm in the z-direction and/or an outer maximum height of 440 cm to 450 cm in the z-direction.

3. The aircraft according to claim 1, wherein the fuselage has a first clear width of 460 cm to 480 cm in the y-direction and a second clear width of 450 cm to 480 cm in the z-direction.

4. The aircraft according to claim 1, wherein the lower deck is formed continuously in the longitudinal direction of the fuselage, wherein the lower deck has a forward cargo space, an aft cargo space and, in the region of a wing box, a through-loading space which connects the forward cargo space and the aft cargo space.

5. The aircraft according to claim 4, wherein the through-loading space in the region of the wing box or the landing gear is designed in such a way that, when the lower deck is loaded, cargo containers can be loaded through from the aircraft nose and/or from the aircraft tail.

6. The aircraft according to claim 4, wherein the through-loading space has a minimum width in the y-direction of the aircraft of 240 cm to 270 cm and/or of 150 cm to 180 cm.

7. The aircraft according to claim 1, wherein at least one first loading door for loading and unloading the upper deck and/or at least one second loading door for loading and unloading the lower deck are arranged in the barrel section, wherein preferably the first loading door is arranged in a nose region and the second loading door is arranged in a tail region or the second loading door is arranged in the nose region and the first loading door is arranged in the tail region on opposite sides of the aircraft.

8. The aircraft according to claim 4, wherein:
a plurality of plates and/or C-shaped beams extending transversely to the longitudinal direction of the aircraft, in particular as part of the wing box, which are spaced apart from one another in the longitudinal direction of the aircraft and are connected to a fuselage structure, in particular frames, of the aircraft.

9. The aircraft according to claim 8, wherein the plates each have at least one passage opening formed in the longitudinal direction of the aircraft, through which the through-loading space extends.

10. The aircraft according to claim 8, wherein the wing box has a plurality of crossbeams (extending in the y-direction), which are arranged above the plates in the z-direction and interact with the plates to stiffen the fuselage structure.

11. The aircraft according to claim 10, wherein wing box comprises a plurality of longitudinal beams extending in the longitudinal direction of the aircraft and connecting the crossbeams to each other.

12. The aircraft according to claim 1, wherein the wings of the aircraft are designed to be angled in the z-direction, wherein the wings have a larger angle of inclination (SW1) relative to a reference axis (RA1) extending in the y-direction in each case starting from the fuselage then towards a free wing tip.

13. The aircraft according to claim 1, wherein the fuselage has a fuselage structure extension on both sides in the y-direction to accommodate the landing gear, which forms a free space into which the respective landing gear can be folded at least in sections.

14. The aircraft according to claim 4, wherein the landing gears each have at least one axis of rotation about which the landing gears can be pivoted for retraction and extension, wherein the two axes of rotation have a distance between 930 cm and 970 cm in the y-direction and the through-loading space has a clear width between 240 cm and 270 cm or the two axes of rotation have a distance between 750 cm and 800 cm in the y-direction and the through-loading space has a clear width between 300 cm and 340 cm.

15. A cargo container for transporting cargo items in an aircraft, comprising a trapezoidal base body having a base area and a ceiling area arranged opposite each other, wherein the base area comprises at least one fastening element, which can be connected to a fastening device of the aircraft, and wherein
the base area has at least one first longitudinal side of at least 240 cm, in particular 244 cm, and the ceiling area has at least one second longitudinal side of at least 315 cm, in particular 317 cm, wherein
the cargo container has an overall height of at least 99 cm to a maximum of 130 cm, in particular 114.5 cm.

16. A method, in particular for loading an aircraft in accordance with claim 1, wherein the lower deck of the aircraft has a forward cargo space, an aft cargo space and, in the region of a wing box, a through-loading space which connects the forward cargo space and the aft cargo space, and the lower deck has a forward loading opening which can be closed by a loading door, wherein during a loading operation at least one cargo item, in particular a cargo container, is introduced through the forward loading opening into the forward cargo space and is then loaded through the through-loading space into the aft cargo space.

17. A method for reconfiguring an aircraft, in particular an aircraft according to claim 1, in which a preferably foldable module having a floor and at least two side walls preferably hinged to the floor is introduced into the aircraft via a loading door and mounted on the lower deck, preferably in the front area of the aircraft, in order to provide passenger seats in the lower deck, wherein the module has pre-assembled seats and/or holding devices for mounting seats preferably during the introduction.

18. An aircraft for transporting cargo and/or passengers, having a fuselage which extends in a longitudinal direction and has an upper deck, in particular main deck, and a lower deck, which are separated from one another by a floor, wherein the fuselage has a barrel section with a cross-sectional profile for accommodating cargo items and/or passengers, wherein the aircraft is designed as a low-wing or mid-wing configuration, wherein
the lower deck has a forward cargo space, an aft cargo space and, in the region of a wing box, a through-loading space which connects the forward cargo space and the aft cargo space, wherein the through-loading space is designed in the region of the wing box or of the landing gear in such a way that, when the lower deck is loaded, cargo containers can be loaded through from the aircraft nose and/or from the aircraft tail.
